(19) United States
(12) Patent Application Publication
(10) Pub. No.: US 2025/0168793 A1
(43) Pub. Date: May 22, 2025

(54) METHOD FOR DETECTING DOWNLINK CONTROL CHANNEL

(71) Applicant: Samsung Electronics Co., Ltd., Suwon-si, Gyeonggi-do (KR)

(72) Inventors: Qi ZHANG, Beijing (CN); Tong SU, Beijing (CN); Feifei SUN, Beijing (CN)

(21) Appl. No.: 18/833,712

(22) PCT Filed: Jan. 25, 2023
(86) PCT No.: PCT/KR2023/001116

§ 371 Date: Jul. 26, 2024

(30) Foreign Application Priority Data
Jan. 28, 2022 (CN) 202210108436.7
Nov. 4, 2022 (CN) 202211379777.4
Dec. 16, 2022 (CN) 202211627557.9
Dec. 28, 2022 (CN) 202211702052.4

(51) Int. Cl. H04W 56/00; H04L 27/26; H04W 72/0453; H04W 72/231

(52) U.S. Cl. CPC H04W 56/0015; H04L 27/26025; H04W 72/0453; H04W 72/231

(57) ABSTRACT

The present disclosure provides a method and apparatus for detecting a Physical Downlink Control Channel (PDCCH). A method performed by a terminal in a wireless communication system, comprising: determining a frequency domain region in which a control resource set (CORESET) is located, wherein the frequency domain region in which the CORESET is located comprise at least a part of a frequency domain region of CORESET0 determined based on a master information block (MIB) configuration; and performing Physical Downlink Control Channel (PDCCH) detection based on the determined frequency domain region in which the CORESET is located.

### TECHNICAL FIELD

The present application relates to a method and device for detecting a downlink control channel, and more particularly, to a method and device for detecting a downlink control channel based on the frequency domain region in which the control resource set (CORESET) is located.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

A method and device for detecting a downlink control channel based on the frequency domain region in which the control resource set (CORESET) is located is required.

### Solution to Problem

According to a method of the present disclosure, there is provided a method performed by a terminal in a wireless communication system, which comprises: determining a frequency domain region in which a control resource set (CORESET) is located, wherein the frequency domain region in which the CORESET is located comprise at least a part of a frequency domain region of CORESET0 determined based on a master information block (MIB) configuration; and performing Physical Downlink Control Channel (PDCCH) detection based on the determined frequency domain region in which the CORESET is located.

In one embodiment, the frequency domain region of CORESET0 determined based on the Master Information Block (MIB) configuration comprises at least one of the following: a corresponding frequency domain region of a predefined configuration corresponding to a specific frequency band; and a frequency domain region in a configuration in a configuration table corresponding to a specific frequency band. In respective specific embodiments, the terminal determines the frequency domain area where the control resource set CORESET is located based on the obtained bandwidth information of the cell and the minimum bandwidth capability supported by the terminal. More specifically, in some embodiments, when the bandwidth information of the cell acquired by the terminal and the minimum bandwidth capability supported by the terminal meet specific conditions, the frequency domain area of CORESET0 determined by the main information block MIB configuration includes: the corresponding frequency domain area of the predefined configuration corresponding to the specific frequency band. In other embodiments, when the bandwidth information of the cell acquired by the terminal and the minimum bandwidth capability supported by the terminal meet another specific condition, the frequency domain area of CORESET0 determined by the main information block MIB configuration includes the frequency domain area in configuration of the configuration table corresponding to the specific frequency band. In a further embodiment, the terminal obtains the cell bandwidth through at least one of the following: frequency location where the terminal's radio frequency RF bandwidth center is located, and global synchronization channel number determined based on the RF reference frequency where the terminal's RF bandwidth center is located.

In one embodiment, the frequency domain region in which the control resource set (CORESET) is located is determined according to at least one of the following: a frequency domain region of CORESET0 determined based on the master information block (MIB) configuration; and/or a predefined frequency domain region.

In one embodiment, the frequency domain region in which the control resource set (CORESET) is located has a maximum integer number of resource blocks RBs in a channel bandwidth corresponding to a predefined frequency domain region.

In one embodiment, the predefined frequency domain region comprises one of the following:

a frequency domain region determined based on a cell bandwidth and/or a frequency domain starting point; a frequency domain region determined by the following: a frequency position and channel bandwidth determined according to a SSB specific subcarrier; a frequency domain region occupied by the SSB; a frequency domain region determined by the following: a frequency position and channel bandwidth determined by a specific subcarrier in CORESET0 of the Master Information Block (MIB) configuration; and a frequency domain region determined based on a part of a frequency domain region occupied by the SSB.

In one embodiment, the SSB specific subcarrier comprise one of the following: a first subcarrier of the 10th resource block RB of the SSB, a subcarrier with the highest index in the SSB, and a subcarrier with the lowest index in the SSB; or

In one embodiment, the specific subcarrier in CORESET0 of the Master Information Block (MIB) configuration comprises one of the following: a frequency domain center subcarrier of CORESET0, a subcarrier with the highest index in the frequency domain of CORESET0, and a subcarrier with the lowest index in the frequency domain of CORESET0.

In one embodiment, the frequency domain center subcarrier of CORESET0 is a first subcarrier of the Xth RB, and wherein X is a number of RBs of the CORESET0 determined by the master information block (MIB) configuration divided by 2.

In one embodiment, a part of the frequency domain region occupied by the SSB is a frequency domain region corresponding to all of frequency domain positions of a Primary Synchronization Signal (PSS) and a Secondary Synchronization Signal (SSS), and a part of frequency domain positions in Physical Broadcast Channel (PBCH)

In various embodiments, the method further comprises: determining a specific search space, wherein the specific search space is spaced by a predefined value in time domain from a search space 0 determined based on the MIB configuration, and wherein the Physical Downlink Control Channel (PDCCH) detection is also performed based on the determined specific search space.

In one embodiment, the specific search space is indicated in Physical Broadcast Channel (PBCH); or the predefined value is indicated in the PBCH.

In one embodiment, the predefined values include at least one of the following: the symbol number interval delta0 between the first symbol of the specific search space and the first symbol of search space 0; the time slot interval delta1 between the specific search space and search space 0; and the system frame number interval delta2 between a specific search space and search space 0.

In another embodiment, the frequency domain location of CORESET0 is determined by terminal according to the received truncated SSB received and the first CORESET0 table. In one embodiment, the first CORESET0 table is configured by the network device to the terminal, and the first CORESET0 table includes one or more of the following elements: index, SS/PBCH block and CORESET multiplexing pattern, number of RBs included in CORESET, number of symbols included in CORESET, and offset value. In an optional embodiment, the first CORESET0 table is associated with the terminal device capability. In another optional embodiment, the first CORESET0 table is associated with the synchronization raster where the RF bandwidth center of the terminal device is located. In various embodiments, the synchronization raster is a specific synchronization raster or one of a plurality of specific synchronization rasters predefined by the system or notified to the terminal device by signaling. In another optional embodiment, the first CORESET0 table is associated with the RF reference frequency where the RF bandwidth center of the terminal device is located. The RF reference frequency where the RF bandwidth center is located is a specific RF reference frequency, or any one of several specific RF reference frequencies. In various embodiments, the specific RF reference frequency is a specific RF reference frequency or one of a plurality of specific RF reference frequencies that are predefined by the system or notified to the terminal equipment by signaling.

According to another aspect of the present disclosure, there is provided a terminal comprising: a transceiver; and at least one processor connected to the transceiver and configured to perform the above methods.

According to another aspect of the present disclosure, there is provided a method performed by a base station, the method comprising: transmitting a specific control resource set CORESET0 configuration to a terminal; and transmitting a Physical Downlink Control Channel (PDCCH) to the terminal based on a frequency domain region determined by the specific control resource set CORESET0 configuration.

In one embodiment, the frequency domain region determined by the specific control resource set CORESET0 configuration comprises at least one of the following: a corresponding frequency domain region in a predefined configuration corresponding to a specific frequency band; a frequency domain region corresponding to a configuration of a configuration table corresponding to a specific frequency band; and a frequency domain region determined based on a cell bandwidth and/or a frequency domain starting point.

In one embodiment, the method further comprises transmitting a specific search space configuration to the terminal, wherein transmitting the PDCCH is further based on the search space configuration.

In one embodiment, information of the specific search space configuration is indicated in Physical Broadcast Channel (PBCH).

In one embodiment, information of the specific search space configuration comprises a predefined value of an interval in time domain between the specific search space and search space 0 determined based on the MIB configuration.

In one embodiment, the predefined values comprise at least one of the following: a symbol interval delta0 between a first symbol of the specific search space and a first symbol of search space 0; a slot interval delta1 between the specific search space and search space 0; and a system frame number interval delta2 between the specific search space and search space 0.

According to another aspect of the present disclosure, there is provided a base station comprising: a transceiver; and at least one processor connected to the transceiver and configured to perform the above methods.

According to one aspect of the present disclosure, a method performed by a terminal in wireless communication is provided, including: determining the frequency domain resources of the initial downlink bandwidth part (BWP) based on the specific RB of the SSB within the RF bandwidth of the terminal device; monitoring and receiving the downlink channel based on the determined initial downlink BWP. In one embodiment, the specific RB of the SSB includes the RB with the lowest index of the SSB within the RF bandwidth of the terminal device. The frequency domain resource for determining the initial downlink BWP also includes determining the location of the RB with the lowest index of the initial downlink BWP based on the offset which is the number of RBs between the RB with the lowest index of the SSB within the RF bandwidth of the terminal device and the RB with the lowest index of the initial downlink BWP. In one embodiment, the offset is notified via high-layer signaling through a network device(s). In a further embodiment, the determined initial downlink BWP is part or all of the initial downlink BWP.

According to another aspect of the present disclosure, there is provided a terminal comprising: a transceiver; and at least one processor connected to the transceiver and configured to perform the above method.

According to another aspect of the present disclosure, a method executed by a base station is provided. The method includes: notifying a terminal device of the frequency domain resources of the initial downlink bandwidth part (BWP); transmitting the downlink channel in the initial downlink BWP. In one embodiment, the frequency domain resource for notifying the initial downlink bandwidth part (BWP) includes notifying the terminal of an offset, which represents the number of RBs between the RB with the lowest index of the SSB within the RF bandwidth of the terminal device and the RB with the lowest index of the initial downlink BWP. In one embodiment, the offset is sent through system message via a network device(s), for examiner, by being notified through MIB or SIB message. In a further embodiment, the initial downlink BWP of the notified terminal device is part or all of the initial downlink BWP.

According to another aspect of the present disclosure, there is provided a base station comprising: a transceiver; and at least one processor connected to the transceiver and configured to perform the above method.

### Advantageous Effects of Invention

The disclosure relates to a 5G or 6G communication system for supporting a higher data transmission rate.

### BRIEF DESCRIPTION OF DRAWINGS

FIG. 1 is an overall structure of a wireless network;

FIG. 2a illustrates a transmission path and reception path;

FIG. 2b illustrates a transmission path and reception path;

FIG. 3a is structural diagrams of UE;

FIG. 3b is structural diagrams of base station;

FIG. 4 illustrates a schematic structural diagram of a Synchronization Signal/Physical Broadcast Channel (SS/PBCH) block;

FIG. 5 illustrates a schematic diagram in which a frequency band of control resource set 0 will exceed cell bandwidth or terminal bandwidth capability;

FIG. 6 illustrates schematic diagrams of truncation of CORESET0 according to various embodiments of the present disclosure;

FIG. 7 illustrates schematic diagrams of truncation of CORESET0 according to various embodiments of the present disclosure;

FIG. 8 illustrates schematic diagrams of truncation of CORESET0 according to various embodiments of the present disclosure;

FIG. 9 illustrates schematic diagrams of truncation of CORESET0 according to various embodiments of the present disclosure;

FIG. 10 illustrates schematic diagrams of detecting Control Channel Elements (CCEs) using different aggregation levels according to an embodiment of the present disclosure;

FIG. 11a illustrates schematic diagrams of detecting Control Channel Elements (CCEs) using different aggregation levels according to an embodiment of the present disclosure;

FIG. 11b illustrates schematic diagrams of detecting Control Channel Elements (CCEs) using different aggregation levels according to an embodiment of the present disclosure;

FIG. 11C illustrates schematic diagrams of detecting Control Channel Elements (CCEs) using different aggregation levels according to an embodiment of the present disclosure;

FIG. 12a illustrates schematic diagrams of detecting a channel using a new search space 0 according to an embodiment of the present disclosure;

FIG. 12b illustrates schematic diagrams of detecting a channel using a new search space 0 according to an embodiment of the present disclosure;

FIG. 13 illustrates a schematic diagram of detecting a channel using a configuration of control resource set CORESET0 and a new search space 0 according to an embodiment of the present disclosure; and

FIG. 14 illustrates a schematic diagram of receiving a downlink control channel with a new frequency band being introduced according to an embodiment of the present disclosure.

FIG. 15 illustrates a flowchart of a method performed by a terminal according to an embodiment of the present disclosure.

FIG. 16a illustrates schematic diagram of the PUCCH resources.

FIG. 16b illustrates schematic diagram of the PUCCH resources.

FIG. 17a illustrates schematic diagram of the PUCCH resources.

FIG. 17b illustrates schematic diagram of the PUCCH resources.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The solutions of the embodiments of the present application may be applied to various communication systems, for example: global system for mobile communications (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD), universal mobile telecommunication system (UMTS), worldwide interoperability for microwave access (WiMAX) communication system, 5th generation (5G) system or new radio (NR) and the like. In addition, the solutions of the embodiments of the present application may be applied to future-oriented communication technologies.

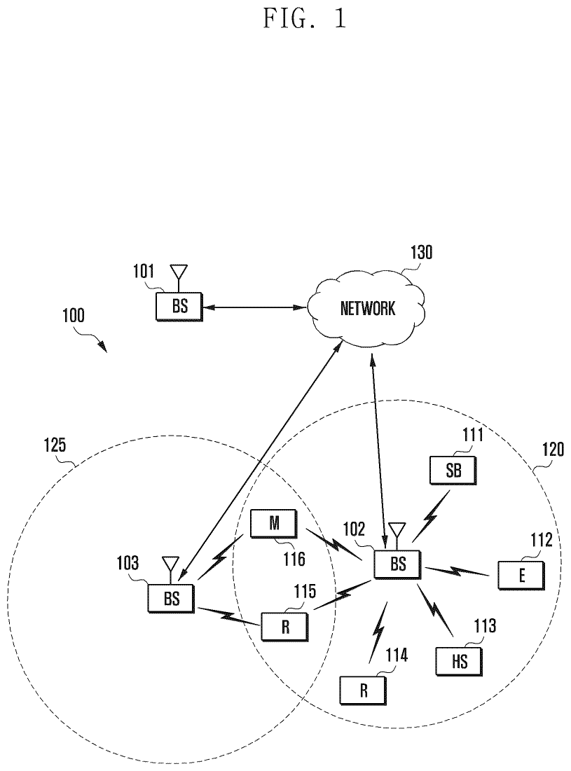

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

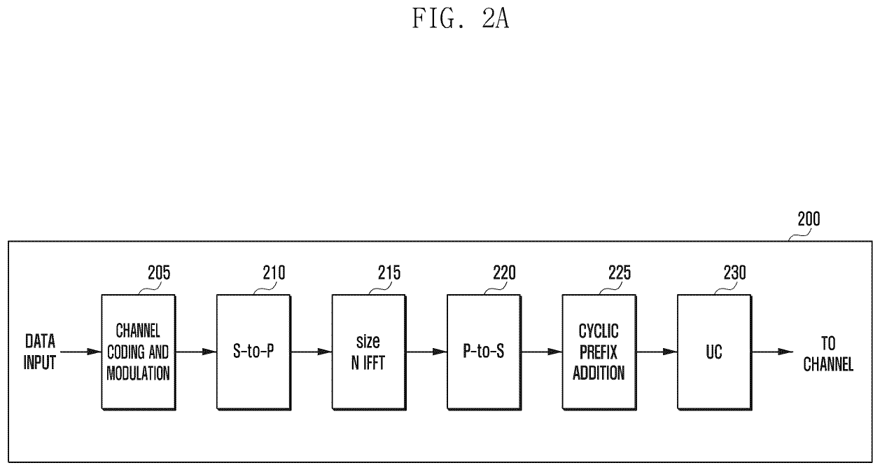

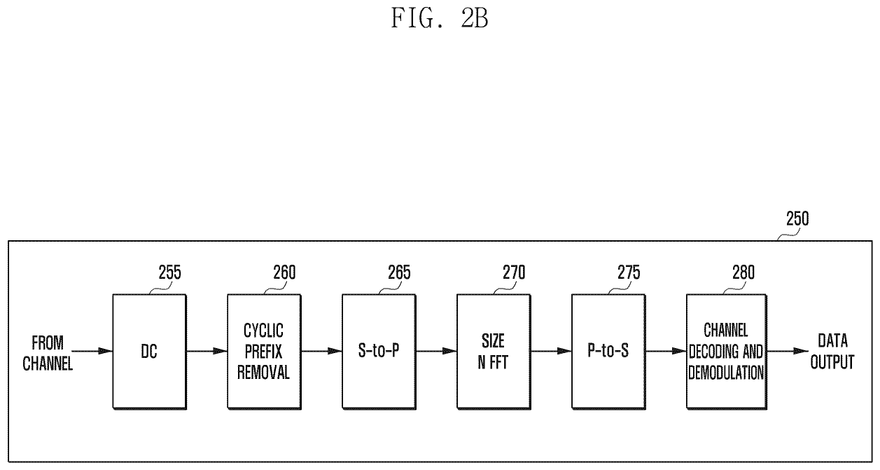

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

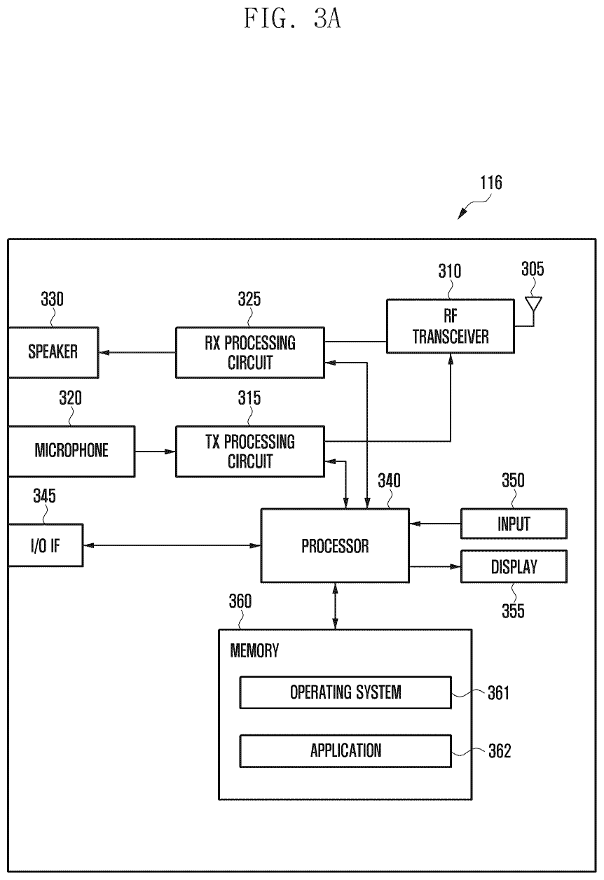

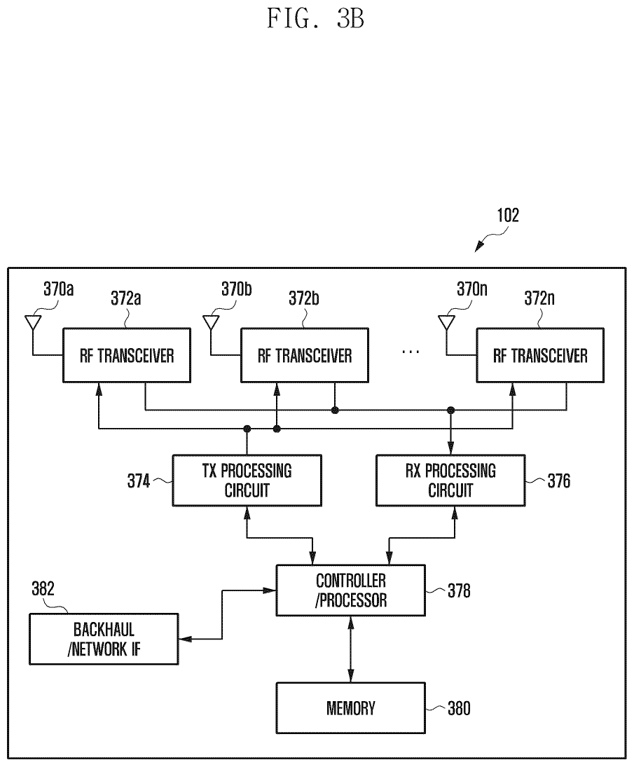

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Exemplary embodiments of the present disclosure are further described below in conjunction with the accompanying drawings.

The text and figures are provided by way of example only to assist readers in understanding the present disclosure. They are not intended and should not be construed to limit the scope of the present disclosure in any way. While certain embodiments and examples have been provided, based on the disclosure herein, it will be apparent to those skilled in the art that the illustrated embodiments and examples may be changed without departing from the scope of the present disclosure.

Before initially randomly accessing to a New Radio (NR) system, a UE needs to perform downlink synchronization, receive necessary configuration of SIB1, and then perform the initially randomly accessing according to the received SIB1 parameters. The NR system is devised with Primary Synchronization Signal (PSS) and Secondary Synchronization Signal (SSS) for downlink synchronization, and transmits MIB (Master Information Block) in the Physical Broadcast Channel (PBCH).

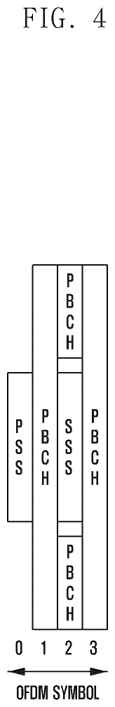

PSS and SSS occupy 1 symbol and 127 subcarriers in the time-frequency domain, and PBCH occupies 3 symbols and 240 subcarriers in the time-frequency domain, as illustrated in FIG. 4. The synchronization signals PSS, SSS and PBCH channels collectively constitute an SSB (SS/PBCH Block).

The protocol specifies the global synchronization signal GSCN (Global Synchronization Channel Number) supported by the frequency band, which is used for rapid downlink synchronization at the frequency band position. The subcarrier with a subcarrier number of 120 in the SSB shall be aligned with the synchronization raster.

5G (the fifth-generation) has been optimized and devised in systems for enhanced mobile broadband (eMBB), enhanced Ultra-Reliable Low Latency (eURLLC), and enhanced Machine Type Communication (eMTC).

In order to better support machine communication, 3GPP (the 3rd generation partnership project) defines a simplified UE capability type (reduced capability UE, redcap UE). Compared with other UEs, this type of UE has lower support capability, such as fewer supported antennas, smaller supported bandwidth and the like, and hence has lower energy consumption and longer battery life.

A Redcap (reduced capability) terminal has a smaller bandwidth than an eMBB terminal under the minimum requirement of NR. For example, the protocol introduces the terminal capability of 5 MHz bandwidth, where the minimum number of RBs (Resource Block) of the current control resource set 0 (CORESET0) is 24, when the subcarrier spacing is 30 KHz, the bandwidth occupied by CORESET0 is 8.64 MHZ, which exceeds the bandwidth range of reduced-capability terminals. In addition, the protocol also needs to support frequency bands (3 MHz to 5 MHz) with a bandwidth of less than 5 MHz for some railway scenarios, such as the Future Railway Mobile Communication System (FRMCS), new utilities (smart utilities) and the like (band RMR900 band, n8, n26, n28). The minimum channel bandwidth currently supported by these frequency bands is 5 MHz, and when a bandwidth of 3 MHz supported by system is introduced, the bandwidth occupied by the control channel resource set 0 (CORESET0) across the subcarrier spacing of 15 KHz is 4.32 MHz, which exceed the bandwidth that can be supported by the base station. The detection and reception of the Physical Downlink Control Channel (PDCCH) also needs to adapt to reduced-capability terminals and the minimum system bandwidth value, otherwise the control channel detection performance will be caused to be degraded, which would frequently trigger radio link failures, deteriorating the system performance.

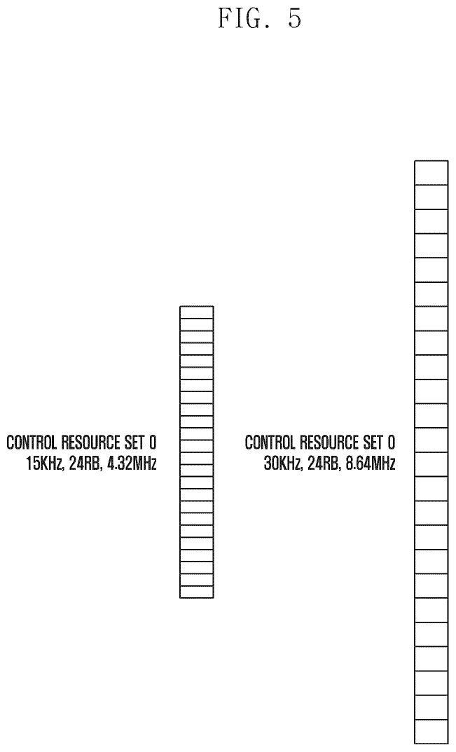

In view of the above scenarios, the present application proposes a method for detecting a downlink control channel, so as to improve the success rate of detecting the Physical Downlink Control Channel (PDCCH), thereby enhancing system performance. The existing control resource set 0 is in a configuration of a predefined table. A terminal searches the table used according to the minimum channel bandwidth supported by the frequency band in which it is located. The minimum channel bandwidth supported in the table is 5 MHz. With introducing a system bandwidth of 3-5 MHz or a reduced-capability terminal with 5 MHz, the frequency bands of the control resource set 0 will exceed the cell bandwidth or the terminal bandwidth capability, as illustrated in FIG. 5.

Method 1: A terminal truncates the control resource set 0 in the frequency domain, and performs downlink control channel detection according to the search space 0 and the truncated control resource set 0.

The method for the terminal to truncate CORESET0 in the frequency domain comprises at least one of the following sub-methods.

Sub-method 1: The terminal truncates CORESET0 according to a predefined frequency domain region, wherein the predefined frequency domain region is determined by a frequency position determined according to a position of a specific subcarrier of the SSB and channel bandwidth. Specifically, in this method, the terminal first determines whether it is a reduced-capability terminal and the minimum bandwidth capability is a predefined value, and/or the CORESET0 subcarrier spacing is a predefined value. When these conditions are met, the terminal truncates CORESET0 according to the predefined frequency domain region. Since the frequency domain region occupied by the SSB may not be an integer number of common RBs, the frequency domain region truncated with the frequency domain position determined through the SSB may have non-integer number of common RBs. At this point, the common RBs defined according to the subcarrier spacing corresponding to CORESET0 should be selected to define the truncation, such that the truncated CORESET0 has the largest integer of RB value in the predefined frequency domain, wherein the predefined frequency domain region is defined by one of the following rules:
Aligning the center frequency of the radio frequency of the terminal with the center of the first subcarrier of the 10th RB in the SSB, the bandwidth being the frequency domain position of the predefined value
Aligning the frequency of the upper side frequency of the terminal with the subcarrier with the highest index in the SSB, the bandwidth being the frequency domain position of the predefined value
Aligning the frequency of the lower side frequency of the terminal with the subcarrier with the lowest index in the SSB, the bandwidth being the frequency domain position of the predefined value
The frequency domain position occupied by the SSB

For the terminal that does not meet the determination conditions, it looks up the CORESET0 table through the minimum channel bandwidth supported by the frequency band in which it is located, SSB subcarrier spacing and PDCCH subcarrier spacing, and determines the configuration of the CORESET0 from the CORESET0 table found according to the configuration in the MIB.

This method facilitates the reception of the control channel by make CORESET0 to be within the radio frequency bandwidth of the terminal, and at the same time, the method reduces the radio frequency retune of the terminal, and reduces the complexity and energy consumption of the terminal.

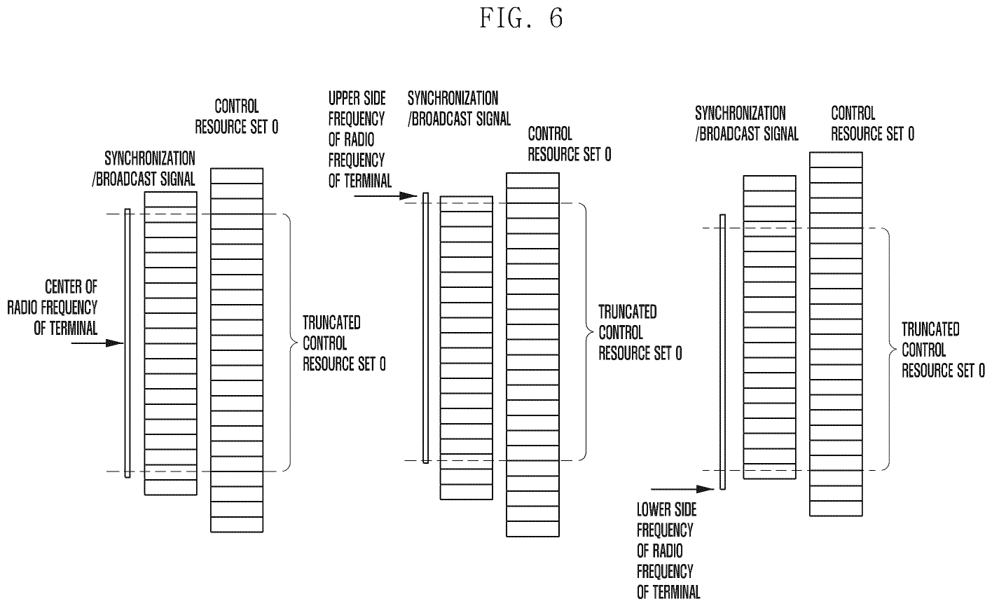

In one embodiment, when the cell in which the terminal is located is configured with a CORESET0 subcarrier spacing of 30 KHz, and the terminal is a reduced-capability whose with a maximum channel bandwidth of 5 MHz, the terminal truncates the CORESET0 according to a predefined frequency domain position, and the truncated CORESET0 has the maximum integer number of RBs in the radio frequency band of the terminal, wherein the RBs are common RBs determined according to the CORESET0 subcarrier spacing. FIG. 6 illustrates a scenario where when the number of RBs configured for the CORESET0 is 24, the CORESET0 is truncated respectively by placing the center of the radio frequency of terminal on the frequency domain center of the SSB, aligning the frequency of the upper side frequency with the subcarrier with the highest index in the SSB and aligning the frequency of the lower side frequency with the subcarrier with the lowest index in the SSB.

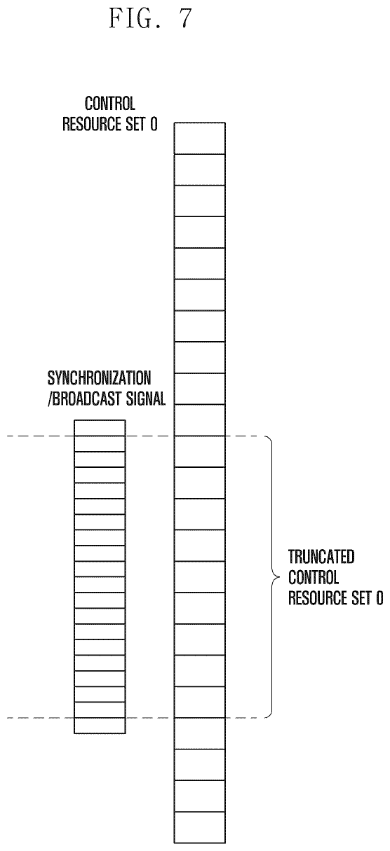

In an embodiment, the terminal first determines that the SSB subcarrier spacing is 15 KHz, the CORESET0 subcarrier spacing is 30 KHz, and when the terminal itself is a reduced-capability terminal with a maximum channel bandwidth of 5 MHz, the terminal truncates the CORESET0 according to the frequency domain position of the SSB, that is, the CORESET0 with the largest number of RBs is truncated in the frequency band of the SSB, as illustrated in FIG. 7. At this point, the terminal bandwidth capability is greater than the SSB bandwidth of 3.6 MHz, and the CORESET0 is truncated with the SSB frequency band without defining the radio frequency position of the terminal. This method is simple and does not require overhead for indication.

Optionally, as an embodiment, in some scenarios, the integer number of RBs included in the truncated CORESET0 can be equal to the integer number of RBs included in the SSB in the RF band of the terminal. This method can be predefined in the protocol. The number and/or location of PRBs of CORESET0 can also be indicated by signaling configuration, such as information bits in MIB or PBCH. Among them, these scenarios include at least one of the following: the RF center of the terminal is aligned with the SSB frequency domain center, the upper frequency point is aligned with the SSB subcarrier with the maximum index, and the lower frequency point is aligned with the SSB subcarrier with the smallest index to truncate CORESET0. In an example, when SSB subcarrier spacing is 15 KHz and CORESET0 subcarrier spacing is 15 KHz, for a 3 MHz system, the truncated CORESET0 and/or truncated SSB can be 15 PRBs (90% band utilization). Or, the truncated CORESET0 and/or truncated SSB can be 16 PRBs. More PRBs will improve the frequency band utilization, but this also requires higher RF design. The number of PRBs of the truncated CORESET0 and the truncated SSB (SSB in the radio frequency band of the terminal) is the same, and the system resources can be used as much as possible to improve utilization. In addition, the UE can directly obtain the number of PRBs of CORESET0 through this predefined method. No signaling configuration is required here, which is more concise. Or signaling overhead can be reduced.

The integer number of RBs included in the truncated CORESET0 are determined according to the subcarrier spacing of CORESET0, or the subcarrier spacing of SSB, or the subcarrier spacing of 15 KHz. The integer number of RBs included in the SSB in the radio frequency band of the terminal are determined according to the subcarrier spacing of the SSB, or the subcarrier spacing of CORESET0, or the subcarrier spacing of 15 KHz.

Sub-method 2: The terminal truncates CORESET0 according to a predefined frequency domain region, wherein the predefined frequency domain region is a frequency domain position determined based on a part of the SSB. Specifically, the terminal first truncates the SSB, and then truncates the CORESET0 according to the frequency domain position of the truncated SSB. Specifically, the terminal determines whether the truncation conditions are met according to the capability and/or the SSB subcarrier spacing and/or the subcarrier spacing of control resource set 0, and then truncates and receives the SSB first, and then determines the frequency domain position where the control resource set 0 is truncated according to the frequency domain position of the truncated SSB and/or configuration of the control resource set 0, so as to obtain the truncated control resource set 0 for detecting the control channel. For the terminal that does not meet the determination conditions, it looks up the CORESET0 table through the minimum channel bandwidth supported by the frequency band in which it is located, SSB subcarrier spacing and PDCCH subcarrier spacing, and determines the configuration of the CORESET0 from the CORESET0 table found according to the configuration in the MIB. This method facilitates the reception of the control channel by enabling CORESET0 to be within the radio frequency bandwidth of the terminal, and at the same time, the method reduces the radio frequency retune of the terminal, and reduces the complexity and energy consumption of the terminal.

In an embodiment, the terminal first performs SSB detection before initial random access, and performs truncation detection with a predefined frequency band bandwidth by taking the first sub-carrier of the 10th RB of the SSB as the center for the SSB, and then receives the CORESET0 according to the same frequency domain position as the truncated SSB.

Sub-method 3: The terminal truncates CORESET0 according to a predefined frequency domain region, wherein the predefined frequency domain region is determined by a specific frequency domain position and channel bandwidth in the configured CORESET0. Specifically, in this method, the terminal first determines whether it is a reduced-capability terminal and the minimum bandwidth capability is a predefined value, and/or the CORESET0 subcarrier spacing is a predefined value. When these conditions are met, the terminal truncates CORESET0 according to the predefined frequency domain region. The truncated CORESET0 has the maximum integer value of RBs in the predefined frequency domain, and the RBs are common RBs determined according to the CORESET0 subcarrier spacing, wherein the predefined frequency domain region is defined by one of the following rules:
Aligning the center frequency of the radio frequency of the terminal with the frequency domain center of the CORESET0, the bandwidth being the frequency domain position of a predefined value, wherein the frequency domain center of the CORESET0 is the first subcarrier of the Xth RB, and the value of X is the number of the RBs configured with CORESET0 divided by 2
Aligning the frequency of the upper side frequency of the terminal with the subcarrier with the highest index of the CORESET0 in the frequency domain, the bandwidth being the frequency domain position of the predefined value
Aligning the frequency of the lower side frequency of the terminal with the subcarrier with the lowest index of the CORESET0 in the frequency domain, the bandwidth being the frequency domain position of the predefined value

For the terminal that does not meet the determination conditions, it looks up the CORESET0 table through the minimum channel bandwidth supported by the frequency band in which it is located, SSB subcarrier spacing and PDCCH subcarrier spacing, and determines the configuration of the CORESET0 from the CORESET0 table found according to the configuration in the MIB.

This method facilitates reception of the control channel, and does not rely on the SSB frequency domain position or reception by enabling the CORESET0 to be within the radio frequency bandwidth of the terminal, which, and has better flexibility.

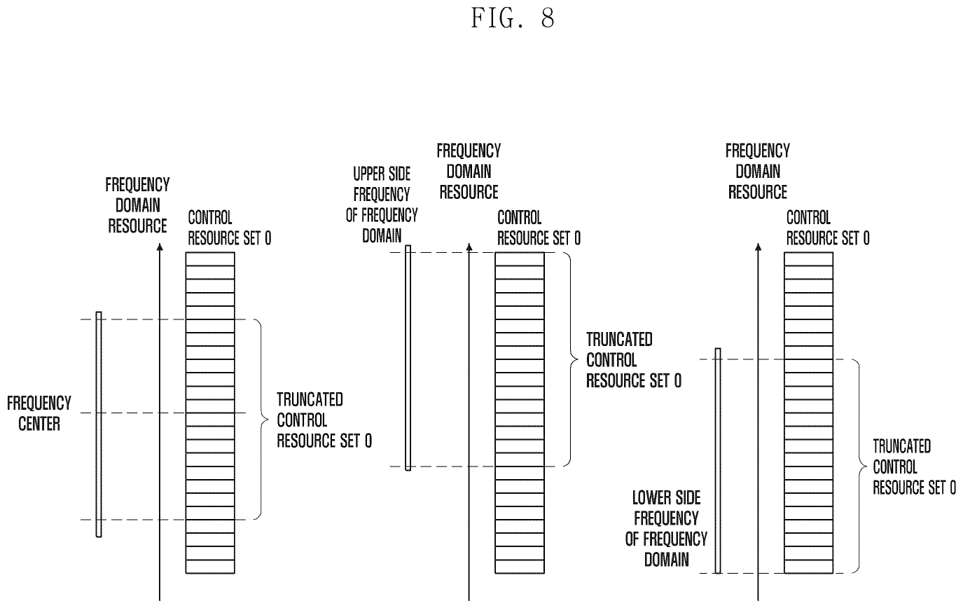

In one embodiment, when the cell in which the terminal is located is configured with a CORESET0 subcarrier spacing of 30 KHz, and the terminal is a reduced-capability terminal with a maximum channel bandwidth of 5 MHz, the terminal truncates the CORESET0 according to a predefined frequency domain position, and the truncated CORESET0 has the maximum integer number of RBs in the radio frequency band of the terminal, wherein the RBs are common RBs determined according to the CORESET0 subcarrier spacing. FIG. 8 illustrates scenarios where when the number of RBs configured for the CORESET0 is 24, the CORESET0 is truncated by respectively placing the center of the radio frequency of terminal on the center of the CORESET0 configuration, aligning the frequency of the upper side frequency with the subcarrier with the highest index in the CORESET0 configuration and aligning the frequency of the lower side frequency with the subcarrier with the lowest index in the CORESET0 configuration.

Sub-method 4: The terminal determines the frequency domain position of the control resource set according to the cell bandwidth and/or the frequency domain starting point and/or the control resource set CORESET0 configuration, and truncates the CORESET0 for control channel detection based on the frequency domain position. This method can support newly introduced smaller cell bandwidths and can reduce the influence on existing protocols. Specifically, in this method, the terminal first determines whether the bandwidth of the cell in which it is located is a predefined value, and when this condition is met, the terminal truncates the configured CORESET0 in the frequency domain according to the cell bandwidth and/or the starting point of the frequency domain and/or the CORESET0 configuration, and receives PDCCH in the frequency domain position of the truncated CORESET. For the terminal that does not meet the determination conditions, it looks up the CORESET0 table according to the minimum channel bandwidth supported by the frequency band in which it is located, SSB subcarrier spacing and PDCCH subcarrier spacing, and determines the CORESET0 configuration from the CORESET0 table found according to the configuration in the MIB.

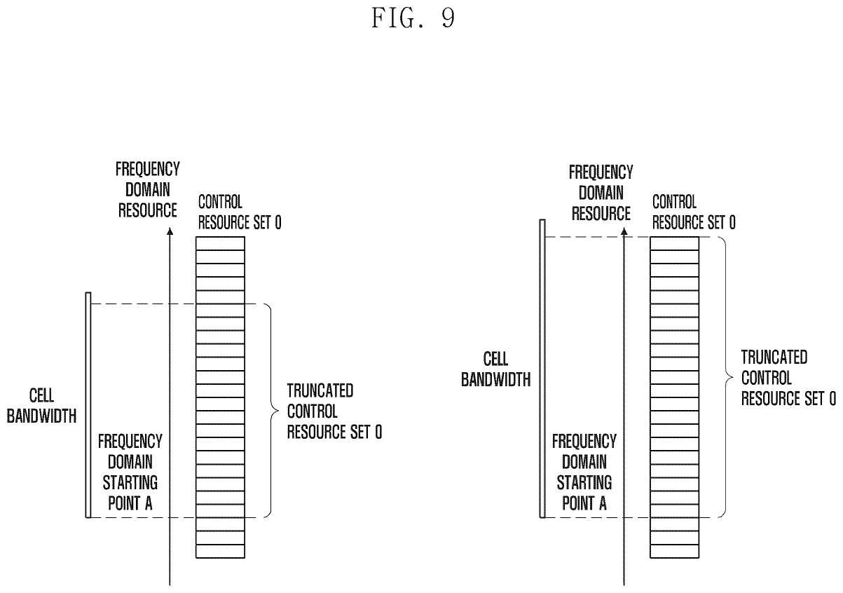

In one embodiment, while the cell bandwidth is 3 MHz and the CORESET0 subcarrier spacing is 15 KHz, the bandwidth is 4.32 MHz when 24 RBs are configured, which exceeds the cell bandwidth. At this point, the terminal first determines that the bandwidth of the cell in which it is located is 3 MHz, then determines the frequency domain position of pointA according to the configuration, and then truncates the maximum number of RBs in the bandwidth from pointA to 3 MHz in the CORESET0 configuration. FIG. 9 illustrates a scenario in which the CORESET0 is truncated when the number of RBs configured with CORESET0 is 24. The protocol may predefine a plurality of cell bandwidths. For different cell bandwidths, under the same CORESET0 configuration, CORESET0 with different numbers of RBs may be truncated. At this point, the protocol can support a plurality of predefined cell bandwidths according to the configuration with existing RB number of CORESET0. In addition, the maximum number of RBs in CORESET0 is guaranteed, and the coverage performance of the downlink control channel is ensured, and there is no need to set different CORESET0 RB configurations for different predefined bandwidths.

The terminal first performs CORESET0 truncation, and then detects one or more PDCCHs on search space 0 and the truncated CORESET0, wherein the DCIs of the PDCCHs may be different in size, and the DCI size on the PDCCH may be determined by the size of the truncated CORESET0. The method can improve the downlink control channel detection performance of the reduced-capability terminals.

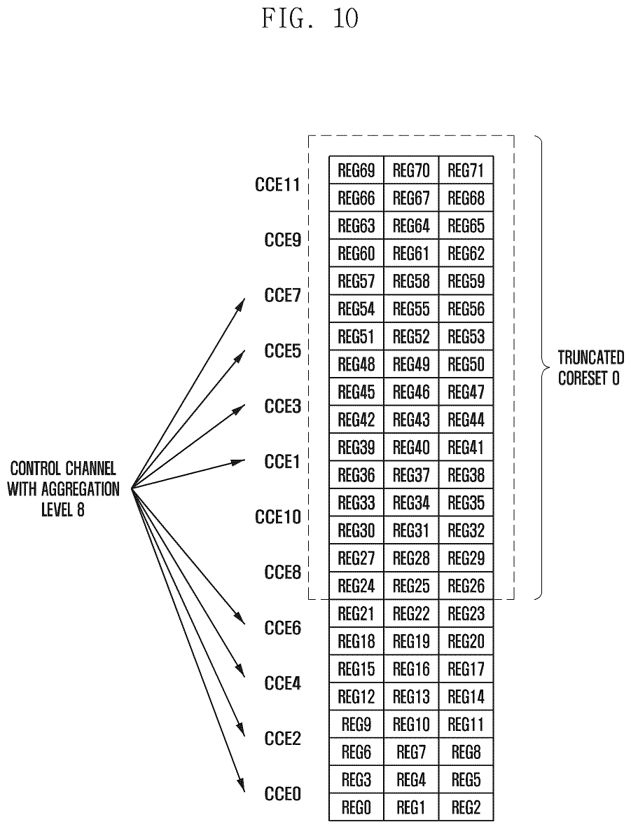

In an embodiment, while the number of RBs configured with CORESET0 is 24 and the number of symbols is 3, when the reduced-capability terminal performs detection of the downlink control channel according to the search space 0 and the truncated CORESET0, the reduced-capability terminal and other terminals have the same detection occasions. The terminal may receive one or more PDCCHs in CORESET0 for indication of the Physical Downlink Shared Channel (PDSCH) of the SIB1 message according to a predefined aggregation level. When the terminal receives a PDCCH, since the reduced-capability terminal truncates CORESET0, the reduced-capability terminal can demodulate the PDCCH signal within the effective bandwidth range. As illustrated in FIG. 10, the Control Channel Element (CCE) of the control channel with aggregation level 8 and with indices of 1, 3, 5, and 7 are in the truncated CORESET0 frequency band, and the reduced-capability terminal performs PDCCH demodulation on these CCEs.

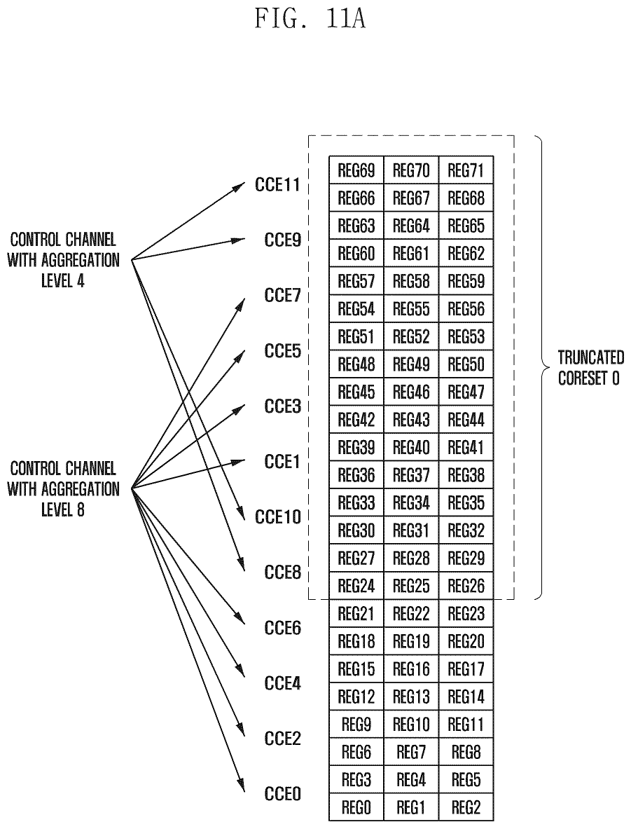

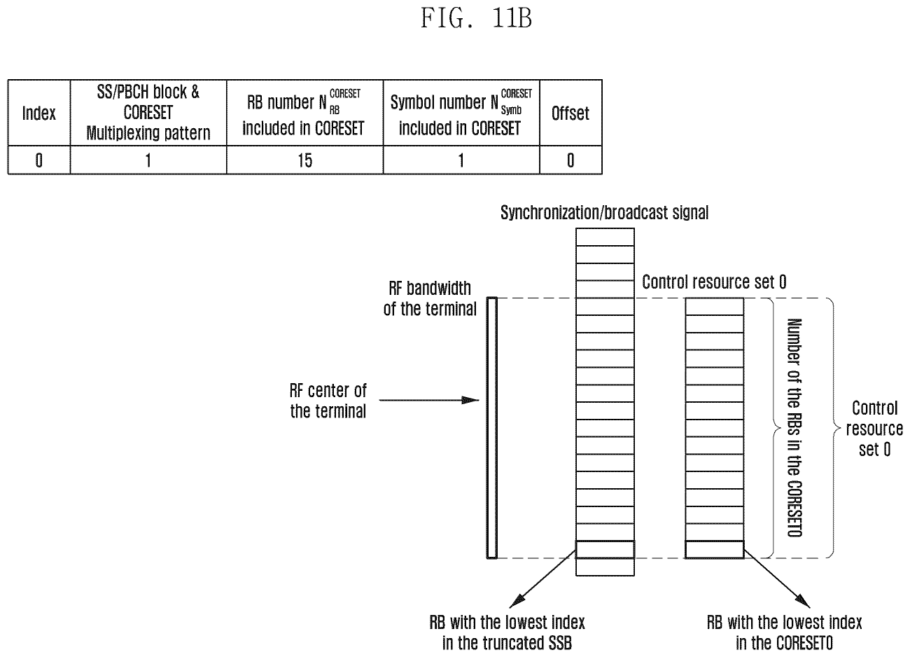

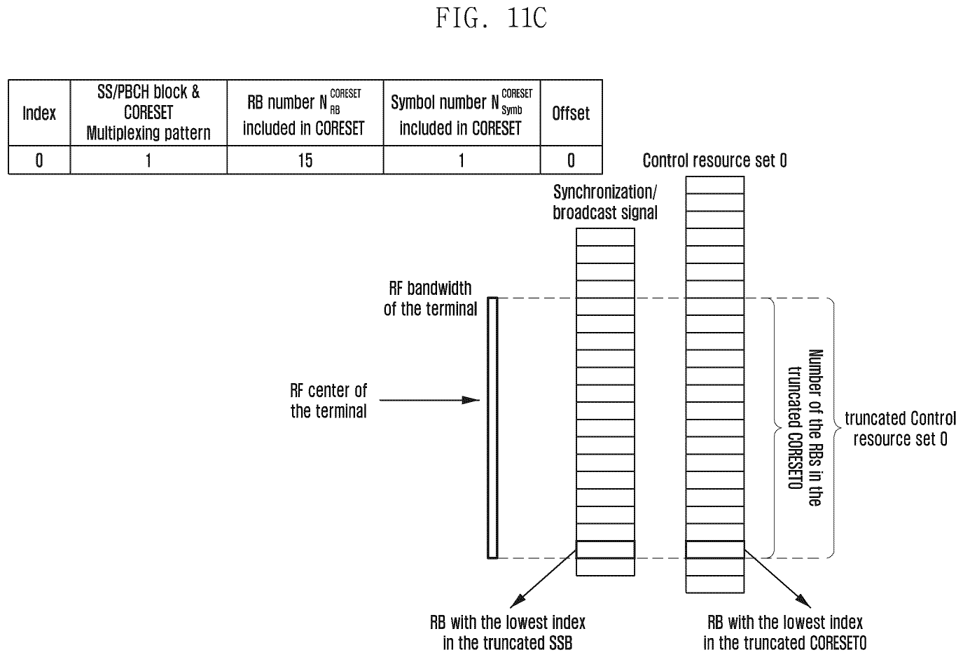

In an embodiment, the terminal may also receive a plurality of PDCCHs in CORESET0, wherein the plurality of PDCCHs may use different aggregation levels. As illustrated in FIG. 11a, the reduced-capability terminal receives the PDCCHs at aggregation level 4 and aggregation level 8 at the same time. At this point, the reduced-capability terminal may detect, in the frequency band range of the truncated CORESET0, all CCEs (with indices of 8, 9, 10, 11) of the control channel with the aggregation level of 4, the terminal may also detect the performance of some CCEs (with indices of 1, 3, 5, and 7) of aggregation level 8, and finally demodulate the control channels by using two demodulation results. Other types of terminals may detect the PDCCHs in different aggregation levels, preferentially detect the PDCCH with the minimum aggregation level, stops blind detection for other candidates after the PDCCH has been preferentially detected.

In an embodiment, while the number of RBs configured with CORESET0 is 24 and the number of symbols is 3, when the reduced-capability terminal detects the PDCCH with aggregation level 4 and the PDCCH with aggregation level 8 on the truncated CORESET0, the DCIs of the two PDCCHs may be different in size, and the two PDCCHs may indicate the same PDSCH, wherein the DCI size of the PDCCH with aggregation level 4 may be determined by the size of the truncated CORESET0, that is, the reduced-capability terminal detects a plurality of DCI format1_0 in the common search space, wherein a parameter N_{RB}^{DL,BWP} of DCI format1_0 is the size of the truncated CORESET0. At the same time, the terminal performs PDSCH reception indicated by DCI format 1_0 in the common search space according to the RB with the lowest index of the truncated CORESET0 as the starting point of the frequency domain resource indication, or performs PDSCH reception according to the RB with the lowest index of CORESET0 as the starting point of the frequency domain resource indication.

Sub-method 5: The terminal determines the frequency domain position of CORESET0 according to the received truncated SSB and the first CORESET0 table. The terminal looks up the CORESET0 table through the minimum channel bandwidth supported by the frequency band where it is located, SSB subcarrier spacing and PDCCH subcarrier spacing. In one embodiment, when the minimum channel bandwidth supported by the frequency band where the terminal is located is 3 MHZ, the SSB subcarrier spacing is 15 KHz, and the PDCCH subcarrier spacing is 15 KHz, the CORESET0 table found is the first CORESET0 table. In another embodiment, the first CORESET0 table is specially designed for the specific minimum channel bandwidth supported by the frequency band where the terminal is located, such as 3 MHz bandwidth. In another embodiment, the first CORESET0 table is specially designed for the RF bandwidth center of the terminal equipment, which is located in a specific synchronization raster or a specific RF reference frequency. Specifically, the terminal first determines whether the minimum bandwidth capability it supports is a predefined value (such as 3 MHz bandwidth), and/or CORESET0 subcarrier spacing is a predefined value, and/or PDCCH subcarrier spacing is a predefined value. When this condition is met, the terminal receives the truncated SSB, and then determines the frequency domain location of control resource set 0 according to the truncated SSB and the first CORESET0 table. The control channel is monitored (detected) according to the obtained control resource set 0.

Optionally, the control resource set 0 determined by the terminal can be a complete control resource set 0 included in the terminal's RF bandwidth, or the control resource set 0 determined by the terminal is a truncated part of a control resource set 0.

For terminals that do not meet the judgment conditions, it looks up the CORESET0 table through the minimum channel bandwidth, SSB subcarrier spacing and PDCCH subcarrier spacing supported by the band, and determines the CORESET0 configuration from the CORESET0 table found according to the configuration in the MIB. This method enables CORESET0 to help control the reception of the control channel within the RF bandwidth of the terminal. At the same time, this method reduces the RF migration of the terminal, and reduces the complexity and energy consumption of the terminal.

In one embodiment, the network device configures the first CORESET0 table of the terminal device. The first CORESET0 table includes one or more of the following elements: index, SS/PBCH block and CORESET multiplexing pattern, number of RBs included in CORESET, number of symbols included in CORESET, and offset value. Wherein, the offset value represents the number of RBs separated between the RB with the smallest index of the truncated SSB and the RB with the smallest index of CORESET0 to be determined. The offset value represents the number of RBs separated between the RB with the smallest index of the SSB before the truncation and the RB with the smallest index of CORESET0 to be determined. The RB number separated is determined according to the subcarrier spacing of SSB, or the subcarrier spacing of CORESET0, or the subcarrier spacing of 15 KHz, as shown in Table 1.

Optionally, the first CORESET0 table can be associated with terminal device capabilities, for example, whether specific minimum system bandwidth or channel bandwidth (such as 3 MHz) is supported, RF bandwidth range of terminal equipment, or minimum bandwidth capability. Only when the terminal is a reduced-capability terminal and the minimum bandwidth capability is a predefined value, and/or CORESET0 subcarrier spacing is a predefined value, the first CORESET0 is used to determine the frequency domain range of CORESET0.

Optionally, the first CORESET0 table can be associated with the synchronization raster where the RF bandwidth center of the terminal device is located. For example, the synchronization raster where the RF bandwidth center is located is a specific synchronization raster, or any one of several specific synchronization rasters. Only when the synchronization raster where the RF bandwidth center of the terminal device is located is a specific synchronization raster, the terminal device uses the first CORESET0 table to determine the frequency domain range of CORESET0. The above specific synchronization raster can be predefined by the system, or it can be a specific synchronization raster or one of several specific synchronization rasters notified to the terminal device by signaling.

Optionally, the first CORESET0 table can be associated with the RF reference frequency where the RF bandwidth center of the terminal device is located. For example, the RF reference frequency where the RF bandwidth center is located is a specific RF reference frequency, or any one of a number of specific RF reference frequencies. When the RF reference frequency where the RF bandwidth center of the terminal equipment is located is a specific RF reference frequency, the terminal equipment will use the first CORESET0 table to determine the frequency range of CORESET0. The above specific RF reference frequency can be predefined by the system, or it can be a specific RF reference frequency or one of several specific RF reference frequencies notified to the terminal equipment through signaling.

In addition, in an example, the number N_{RB}^{CORESET} of RBs included in CORESET in the first CORESET0 table can be one of values of 12 (which can meet the design criterion that the number of RBs in CORESET is a multiple of 6), or 14 (which can provide some flexibility), 16 (which can ensure high spectral utilization in 3 MHz bandwidth). For the case that CORESET includes 12 or 14 RBs, the offset can be one or more of value of 1, 2, 3 or 4. This ensures that CORESET is within the 3 MHz bandwidth and can provide certain flexibility.

In another example, the number N_{symb}^{CORESET} of symbols included in CORESET in the first CORESET0 table can be 4 symbols. This can provide more resources for PDCCH, thus improving the performance of PDCCH.

### Table 1 First CORESET0 Table

TABLE 1

| | SS/PBCH block & | RB number | | |
|---|---|---|---|---|
| | CORESET | N_{RB}^{CORESET} | Symbol number | |
| | Multiplexing | included in | N_{symb}^{CORESET} included | |
| Index | pattern | CORESET | in CORESET | Offest |
| 0 | 1 | 15 | 1 | 0 |
| 1 | 1 | 15 | 2 | 0 |
| 2 | 1 | 15 | 3 | 0 |

| | |
|---|---|
| 3 | Reserved |
| 4 | Reserved |
| 5 | Reserved |
| 6 | Reserved |
| 7 | Reserved |
| 8 | Reserved |
| 9 | Reserved |
| 10 | Reserved |
| 11 | Reserved |
| 12 | Reserved |
| 13 | Reserved |
| 14 | Reserved |
| 15 | Reserved |

The terminal equipment shall conduct SSB detection before initial random access. For SSB, the first subcarrier of the tenth RB of the SSB shall be taken as the center, and shall be used for truncation and detection is performed based on frequency band bandwidth predefined by the terminal or RF bandwidth of the terminal. The method of truncating SSB is as per the predefined rules in sub method 1, which will not be repeated here. The terminal equipment then determines the frequency domain position of the control resource set 0 according to the RB position with the smallest index in the frequency domain of the truncated SSB, the offset value in the first CORESET0 table and the number of RBs included in the CORESET, so as to obtain the control resource set 0, as shown in FIG. 11b. It can be understood that the control resource set 0 determined by the terminal can be a complete control resource set 0 included in the RF bandwidth of the terminal. Optionally, the values of the SS/PBCH block and CORESET multiplexing pattern corresponding to the different indexes are the same, such as ‘1’, which means that the SS/PBCH block and CORESET do not overlap in the time domain.

Optionally, the RB numbers included in the CORESET corresponding to the different indexes are integers greater than or equal to 0, such as but not limited to ‘12’, ‘14’, ‘15’ or ‘16’.

Optionally, the number of RBs included in the CORESET corresponding to the different indexes has the same value.

Optionally, the number of symbols included in the CORESET corresponding to the different indexes is an integer greater than 0, such as but not limited to one of ‘1’, ‘2’, ‘3’, and ‘4’.

In one embodiment, the network device configures the terminal device's first CORESET0 table, which includes one or more of the following: index, SS/PBCH block and CORESET multiplexing pattern, the number of RBs included in CORESET, the number of symbols included in CORESET, and offset value. Wherein, the offset value represents the number of RBs between the RB with the smallest index of the truncated SSB and the RB with the smallest index of CORESET0 to be truncated. The RB number of the interval is determined according to the subcarrier spacing of SSB, CORESET0 or 15 KHz, as shown in Table 1.

Optionally, the first CORESET0 table can be associated with the RF bandwidth range or minimum bandwidth capability of the terminal equipment. That is, when the terminal is a reduced-capability terminal and the minimum bandwidth capability is a predefined value, and/or CORESET0 subcarrier spacing is a predefined value, the first CORESET0 is used to determine the frequency domain range of CORESET0 to be truncated.

Optionally, the first CORESET0 table can be associated with the synchronization raster where the RF bandwidth center of the terminal device is located. For example, the synchronization raster where the RF bandwidth center is located is a specific synchronization raster, or any one of several specific synchronization rasters. When the synchronization raster where the RF bandwidth center of the terminal device is located is a specific synchronization raster, the terminal device uses the first CORESET0 table to determine the frequency domain range of CORESET0. The above specific synchronization raster can be predefined by the system, or it can be a specific synchronization raster or one of several specific synchronization rasters notified to the terminal device by signaling.

Optionally, the first CORESET0 table can be associated with the RF reference frequency where the RF bandwidth center of the terminal device is located. For example, the RF reference frequency where the RF bandwidth center is located is a specific RF reference frequency, or any one of a number of specific RF reference frequencies. When the RF reference frequency of the RF bandwidth center of the terminal equipment is a specific RF reference frequency, the terminal equipment will use the first CORESET0 table to determine the frequency range of CORESET0. The above specific RF reference frequency can be predefined by the system, or can be a specific RF reference frequency or one of a number of specific RF reference frequencies notified to the terminal equipment by signaling.

The terminal equipment shall conduct SSB detection before initial random access. For SSB, the first subcarrier of the tenth RB of the SSB shall be taken as the center, and the terminal predefined band bandwidth or terminal RF bandwidth shall be used for truncation detection. The method of truncating SSB is as per the predefined rules in sub-method 1, which is not be repeatedly described here. The terminal equipment then determines the frequency domain position of the truncated control resource set 0 according to the RB position with the smallest index in the frequency domain of the truncated SSB, the offset value in the first CORESET0 table and the number of RBs included in the CORESET, so as to obtain the truncated control resource set 0, as shown in FIG. 11c. It can be understood that the control resource set 0 determined by the terminal is a truncated part of a control resource set 0.

Optionally, the values of the SS/PBCH block and CORESET multiplexing pattern corresponding to different indexes are the same, such as ‘1’, which means that the SS/PBCH block and CORESET do not overlap in the time domain.

Optionally, the number of RBs included in the CORESET corresponding to different indexes takes an integer greater than or equal to 0, such as but not limited to ‘12’, ‘14’, ‘15’ or ‘16’.

Optionally, the number of RBs included in the CORESET corresponding to different indexes has the same value.

Optionally, the number of symbols included in the CORESET corresponding to different indexes is an integer greater than 0, such as but not limited to one of ‘1’, ‘2’, ‘3’, and ‘4’.

In one embodiment, the terminal equipment can determine the frequency domain resources of the initial downlink bandwidth part according to the RB with the lowest index in the SSB within the RF bandwidth to monitor and receive the downlink channel. For the determination method of SSB within the RF bandwidth of the terminal equipment, please refer to sub methods 1 to 5, which is not be repeatedly described here. Specifically, in one example, the terminal device receives position and bandwidth indication(s), which are used to indicate the frequency domain position of the initial downlink BWP and the number of RBs included. The location and bandwidth indication(s) can be notified to the terminal equipment by the network equipment through high-layer signaling. The terminal equipment determines the frequency domain resource location and size of the initial downlink bandwidth part according to the location and bandwidth indication(s) and the RB with the smallest index of the truncated SSB. Specifically, the terminal first judges whether it is a reduce-capability terminal and whether the minimum bandwidth capability it supports is a predefined value (such as 3 MHz bandwidth). If the conditions are met, the terminal equipment determines the SSB within its RF bandwidth; determines the location of the RB with the lowest index of the initial downlink bandwidth based on the RB with the lowest index in the SSB within its RF bandwidth and offset which is the number of RBs indicating the interval between the RB with the lowest index in the SSB within the RF bandwidth of the terminal equipment and the RB with the lowest index in the initial downlink BWP. The offset can be notified through high-layer signaling through a network equipment(s). The terminal equipment determines the frequency domain resources of the initial downlink BWP according to the location and bandwidth indication(s) and the RB with the lowest index of the initial downlink BWP.

If the terminal equipment determines that the above judgment conditions are not met, the terminal equipment still determines the RB with the lowest index in the initial downlink BWP based on PointA, carrier offset and raster offset according to the existing technology.

Optionally, the determined initial downlink BWP can be a complete initial downlink BWP, that is, the initial downlink BWP is completely included in the RF bandwidth of the terminal equipment. Or the determined initial downlink BWP is a part of the initial downlink BWP, that is, a part of the initial downlink BWP truncated according to the RF bandwidth of the terminal equipment.

This method can make the downlink initial bandwidth part within the RF bandwidth of the terminal and thus facilitating the reception of the control channel and/or data channel. At the same time, this method reduces the RF migration of the terminal, and reduces the complexity and energy consumption of the terminal.

In one embodiment, the terminal equipment determines that the minimum channel bandwidth supported by the frequency band where it is located is 5 MHz. When the minimum bandwidth capability supported by the terminal equipment is 5 MHz, the terminal equipment looks up the CORESET0 table according to the minimum channel bandwidth supported by the frequency band where the terminal is located, SSB subcarrier spacing and PDCCH subcarrier spacing, and determines the CORESET0 configuration from the CORESET0 table found according to the configuration in MIB. When the minimum bandwidth capability supported by the terminal equipment is 3 MHz, the terminal equipment shall determine CORESET0 according to any of the above sub-methods 1 to 4, and detect the PDCCH receiving the scheduled SIB1 message in the determined CORESET0. In this way, the predefined configuration of the system can be simplified. When the minimum bandwidth capability supported by the terminal equipment is not greater than the minimum channel bandwidth supported by the frequency band where it is located, CORESET0 is determined by any method from sub-method 1 to sub-method 4 to ensure that CORESET0 is located in the RF bandwidth of the terminal, thus ensuring the coverage and detection performance of the physical downlink control channel PDCCH. When the minimum bandwidth capability supported by the terminal equipment is greater than the minimum channel bandwidth supported by the frequency band where it is located, the CORESET0 table information with predefined configurations is directly used to determine CORESET0, so as to ensure the coverage and detection performance of the physical downlink control channel PDCCH.

In one embodiment, the terminal equipment determines that the minimum channel bandwidth supported by the frequency band where it is located is 5 MHz. When the minimum bandwidth capability supported by the terminal equipment is 5 MHz, the terminal equipment looks up the CORESET0 table according to the minimum channel bandwidth supported by the frequency band where it is located, SSB subcarrier spacing and PDCCH subcarrier spacing, and determines the CORESET0 configuration from the CORESET0 table found according to the configuration in the MIB; When the minimum bandwidth capability supported by the terminal equipment is 3 MHz, the terminal equipment determines CORESET0 according to the method of sub-method 5 above, and detects the PDCCH receiving the scheduled SIB1 message in the determined CORESET0. With this method, when the minimum bandwidth capability supported by the terminal equipment is not greater than the minimum channel bandwidth supported by the frequency band where it is located, CORESET0 is determined through the first CORESET0 table newly defined in sub-method 5 to ensure that CORESET0 is located in the RF bandwidth of the terminal, so as to ensure the coverage and detection performance of the physical downlink control channel PDCCH without increasing the complexity of the terminal equipment. When the minimum bandwidth capability supported by the terminal equipment is greater than the minimum channel bandwidth supported by the frequency band where it is located, the CORESET0 table information with predefined configurations is directly used to determine CORESET0, so as to ensure the coverage and detection performance of the physical downlink control channel PDCCH.

In one embodiment, the terminal equipment determines that the minimum channel bandwidth supported by the frequency band where it is located is 3 MHz. When the minimum bandwidth capability supported by the terminal equipment is 5 MHz, the terminal equipment determines CORESET0 according to any method in sub-methods 1 to 4; When the minimum bandwidth capability supported by the terminal equipment is 3 MHz, the terminal equipment shall determine CORESET0 according to any of the above sub-methods 1 to 4, and detect the PDCCH receiving the scheduled SIB1 message in the determined CORESET0. In this way, the predefined configuration of the system can be simplified. When the minimum bandwidth capability supported by the terminal equipment is not greater than the minimum channel bandwidth supported by the frequency band where it is located, or the minimum bandwidth capability supported by the terminal equipment is greater than the minimum channel bandwidth supported by the frequency band where it is located, CORESET0 shall be determined by any method from sub-method 1 to sub-method 4 to ensure that CORESET0 is located in the radio frequency bandwidth of the terminal, so as to ensure the coverage and detection performance of the physical downlink control channel PDCCH.

In one embodiment, the terminal equipment determines that the minimum channel bandwidth supported by the frequency band where it is located is 3 MHz. When the minimum bandwidth capability supported by the terminal equipment is 5 MHz, the terminal equipment determines CORESET0 according to any method in sub-methods 1 to 4; When the minimum bandwidth capability supported by the terminal equipment is 3 MHz, the terminal equipment determines CORESET0 according to the method of sub-method 5 above, and detects the PDCCH receiving the scheduled SIB1 message in the determined CORESET0. With this method, when the minimum bandwidth capability supported by the terminal equipment is not greater than the minimum channel bandwidth supported by the frequency band where it is located, the predefined configuration of the system is simplified, so that the determined CORESET0 is located in the RF bandwidth of the terminal equipment, thus ensuring PDCCH coverage and detection performance. When the minimum bandwidth capability supported by the terminal equipment is greater than the minimum channel bandwidth supported by the frequency band where it is located, CORESET0 is determined by the newly defined CORESET0 table in sub-method 5 to ensure that CORESET0 is located in the RF bandwidth of the terminal, thus ensuring the coverage and detection performance of the physical downlink control channel PDCCH.

In one embodiment, the terminal equipment determines that the minimum channel bandwidth supported by the frequency band where it is located is 3 MHz. When the minimum bandwidth capability supported by the terminal equipment is 5 MHz, the terminal equipment determines CORESET0 according to the method of sub-method 5; When the minimum bandwidth capability supported by the terminal equipment is 3 MHz, the terminal equipment determines CORESET0 according to the method of sub-method 5 above, and detects the PDCCH receiving the scheduled SIB1 message in the determined CORESET0. With this method, when the minimum bandwidth capability supported by the terminal equipment is not greater than the minimum channel bandwidth supported by the frequency band where it is located, or when the minimum bandwidth capability of the terminal equipment is greater than the minimum channel bandwidth supported by the frequency band where it is located, CORESET0 is both determined through the method of sub-method 5 to ensure that CORESET0 is located in the RF bandwidth of the terminal, so as to ensure the coverage and detection performance of the physical downlink control channel PDCCH. By adding predefined configuration of the system, complexity increasing of the terminal equipment can be avoided.

In one embodiment, the minimum bandwidth capability supported by the terminal equipment is 5 MHz. When the terminal equipment determines that the minimum channel bandwidth supported by the frequency band where it is located is 3 MHz, the terminal equipment uses any of the above sub-methods 1 to 4 to determine CORESET0; When the terminal equipment determines that the minimum channel bandwidth supported by the frequency band where it is located is 5 MHz, the terminal equipment uses any of the above sub-methods 1 to 4 to determine CORESET0, and detects the PDCCH receiving the scheduled SIB1 message in the determined CORESET0. With this method, when the minimum bandwidth capability supported by the terminal equipment is not greater than the minimum channel bandwidth supported by the frequency band where it is located, or the minimum bandwidth capability supported by the terminal equipment is greater than the minimum channel bandwidth supported by the frequency band where it is located, CORESET0 is determined by any method in sub-methods 1 to 4 to ensure that CORESET0 is located in the RF bandwidth of the terminal, so as to ensure the coverage and detection performance of the physical downlink control channel PDCCH. By adding the predefined configuration of the system, complexity increasing of the terminal equipment can be avoided.

In one embodiment, the minimum bandwidth capability supported by the terminal equipment is 5 MHz. When the terminal equipment determines that the minimum channel bandwidth supported by the frequency band where it is located is 3 MHz, the terminal equipment uses the method of sub-method 5 above to determine CORESET0; When the terminal equipment determines that the minimum channel bandwidth supported by the frequency band where it is located is 5 MHz, the terminal equipment uses any of the above sub-methods 1 to 4 to determine CORESET0, and detects the PDCCH receiving the scheduled SIB1 message in the determined CORESET0. With this method, when the minimum bandwidth capability supported by the terminal equipment is not greater than the minimum channel bandwidth supported by the frequency band where it is located, the predefined configuration of the system is simplified, so that the determined CORESET0 is located in the RF bandwidth of the terminal equipment, and thus ensuring the coverage and detection performance of PDCCH. When the minimum bandwidth capability supported by the terminal equipment is greater than the minimum channel bandwidth supported by the frequency band where it is located, CORESET0 is determined through the CORESET0 table newly defined in sub-method 5 to ensure that CORESET0 is located in the RF bandwidth of the terminal, thus ensuring the coverage and detection performance of the physical downlink control channel PDCCH.

In one embodiment, the minimum bandwidth capability supported by the terminal equipment is 3 MHz. When the terminal equipment determines that the minimum channel bandwidth supported by the frequency band where it is located is 3 MHZ, the terminal equipment uses any of the above sub-methods 1 to 4 to determine CORESET0; When the terminal equipment determines that the minimum channel bandwidth supported by the frequency band where it is located is 5 MHz, the terminal equipment uses any of the above sub-methods 1 to 4 to determine CORESET0, and detects the PDCCH receiving the scheduled SIB1 message in the determined CORESET0. With this method, when the minimum bandwidth capability supported by the terminal equipment is not greater than the minimum channel bandwidth supported by the frequency band where it is located, or the minimum bandwidth capability supported by the terminal equipment is greater than the minimum channel bandwidth supported by the frequency band where it is located, CORESET0 is determined by any method in sub-methods 1 to 4 to ensure that CORESET0 is located in the RF bandwidth of the terminal, so as to ensure the coverage and detection performance of the physical downlink control channel PDCCH. By adding the predefined configuration of the system, complexity increasing of the terminal equipment can be avoided.

In one embodiment, the minimum bandwidth capability supported by the terminal equipment is 3 MHz. When the terminal equipment determines that the minimum channel bandwidth supported by the frequency band where it is located is 3 MHz, the terminal equipment uses the method of sub-method 5 above to determine CORESET0; When the terminal equipment determines that the minimum channel bandwidth supported by the frequency band where it is located is 5 MHz, the terminal equipment uses any of the above sub-methods 1 to 4 to determine CORESET0, and detects the PDCCH receiving the scheduled SIB1 message in the determined CORESET0. With this method, when the minimum bandwidth capability supported by the terminal equipment is not greater than the minimum channel bandwidth supported by the frequency band where it is located, the predefined configuration of the system is simplified, so that the determined CORESET0 is located in the RF bandwidth of the terminal equipment, and thus ensuring the coverage and detection performance of PDCCH. When the minimum bandwidth capability supported by the terminal equipment is greater than the minimum channel bandwidth supported by the frequency band where it is located, CORESET0 is determined through the CORESET0 table newly defined in sub-method 5 to ensure that CORESET0 is located in the RF bandwidth of the terminal, so as to ensure the coverage and detection performance of the downlink control channel PDCCH.

In one embodiment, the minimum bandwidth capability supported by the terminal equipment is 3 MHz. When the terminal equipment determines that the minimum channel bandwidth supported by the frequency band where it is located is 3 MHz, the terminal equipment uses the above sub-method 5 to determine CORESET0; When the terminal equipment determines that the minimum channel bandwidth supported by the frequency band where it is located is 5 MHz, the terminal equipment uses the above sub-method 5 to determine CORESET0, and detects the PDCCH receiving the scheduled SIB1 message in the determined CORESET0. With this method, when the minimum bandwidth capability supported by the terminal equipment is not greater than the minimum channel bandwidth supported by the frequency band where it is located, or the minimum bandwidth capability supported by the terminal equipment is greater than the minimum channel bandwidth supported by the frequency band where it is located, CORESET0 is both determined through sub-method 5 to ensure that CORESET0 is located in the RF bandwidth of the terminal, so as to ensure the coverage and detection performance of the physical downlink control channel PDCCH. By adding predefined configuration of the system, complexity increasing of the terminal equipment can be avoided.

In the context of the present application, “cell bandwidth” or “bandwidth of the cell to be accessed” can be used interchangeably with “minimum channel bandwidth supported by the band where the terminal equipment (or simply “it”) is located”. Optionally, in this application, the terminal equipment determines the cell bandwidth or the size of the frequency band in which the terminal equipment is located. Specifically, the terminal equipment determines the frequency band in which the terminal equipment is located and the minimum channel bandwidth supported by the frequency band through the frequency location where the RF bandwidth center of the terminal is located.

If the frequency position is a specific frequency position, the terminal equipment further determines the frequency band where the terminal equipment is located and the minimum channel bandwidth supported by the frequency band according to the synchronization raster used. A particular frequency position may be a frequency position included in or used by a plurality of frequency bands. In one example, the terminal equipment determines that the frequency where the RF bandwidth center is located is X MHz, which is included in both the frequency range of band #1 and band #2. If the synchronization raster used by the terminal equipment is associated with band #1, the terminal equipment determines that X MHz belongs to the frequency range of band #1, and the terminal equipment determines that the frequency band where it is located is band #1. The terminal equipment further determines the minimum channel bandwidth supported by band #1 according to the subcarrier spacing and the terminal minimum bandwidth capability (or terminal channel bandwidth).

Optionally, in this application, the terminal equipment determines the cell bandwidth or the size of the frequency band where the terminal equipment determines, specifically, the terminal equipment determines the global synchronization channel number through the RF reference frequency where the RF bandwidth center is located. The terminal equipment determines the frequency band where the terminal equipment is located and the minimum channel bandwidth supported by the frequency band according to the global synchronization channel number.

If the RF reference frequency is a specific RF reference frequency, the terminal equipment further determines the frequency band where the terminal equipment is located and the minimum channel bandwidth supported by the frequency band according to the synchronization raster used. A specific RF reference frequency may be a common RF reference frequency included in a plurality of frequency bands, or a common RF reference frequency used by a plurality of frequency bands. In one example, the terminal equipment determines that the RF reference frequency where the RF bandwidth center is located is X MHz, which is included in both the frequency range of band #1 and band #2. If the synchronization raster used by the terminal equipment is associated with band #1, the terminal equipment determines that X MHz belongs to the frequency range of band #1, and the terminal equipment determines that the frequency band where it is located is band #1. The terminal equipment further determines the minimum channel bandwidth supported by band #1 according to the subcarrier spacing and the minimum bandwidth capability (or terminal channel bandwidth) supported by the terminal.

If the global synchronization channel number is a specific global synchronization channel number, the terminal equipment further determines the frequency band where the terminal equipment is located and the minimum channel bandwidth supported by the frequency band according to the synchronization raster used. The specific global synchronization channel number may be a common global synchronization channel number included in multiple frequency bands, or a common global synchronization channel number used by multiple frequency bands. In one example, the terminal equipment determines that the global synchronization channel number corresponding to the frequency where the RF bandwidth center is located is X. X is included in both the global synchronization channel number range of band #1 and the global synchronization channel number range of band #2. If the synchronization raster used by the terminal equipment is associated with the frequency band #1, the terminal equipment determines that the global synchronization channel number X belongs to the frequency band #1, and the terminal equipment determines that the frequency band is the frequency band #1. The terminal equipment further determines the minimum channel bandwidth supported by band #1 according to the subcarrier spacing and the terminal minimum bandwidth capability (or terminal channel bandwidth).

Optionally, different minimum bandwidth capabilities (or terminal channel bandwidth) supported by the terminal equipment are associated with different synchronization rasters, and the terminal equipment searches for frequency points in a band according to one of the synchronization rasters. The terminal equipment determines to use a synchronization raster to search for frequency points according to the minimum bandwidth capability (or terminal channel bandwidth) supported by the terminal equipment. In one example, if the minimum bandwidth capability (or terminal channel bandwidth) supported by the terminal equipment is 3 MHz, and the channel bandwidth of 3 MHz is associated with synchronization raster #1, the terminal equipment uses synchronization raster #1 to search for frequency points in the frequency band; If the minimum bandwidth capability (or terminal channel bandwidth) of the terminal equipment is 5 MHz, and the 5 MHz channel bandwidth is associated with synchronization raster #2, the terminal equipment uses synchronization raster #2 to search for frequency points in the frequency band.

Method 2: The terminal truncates control resource set 0 in the frequency domain, receives a new search space 0 configuration, and uses the newly configured search space 0 and the truncated control resource set 0 to perform downlink control channel detection. This method can improve the detection performance of the downlink control channel by the reduced-capability terminal. The terminal first determines whether it is a reduced-capability terminal and the supported bandwidth is a predefined value. When the conditions are met, the terminal determines the downlink control channel detection occasions according to the newly configured search space 0, and then performs downlink control channel detection according to the truncated control resource set 0. The new search space 0 may be indicated in the PBCH, for example, its indication field may be different from the search space 0; in an alternative embodiment, the new search space may be predefined to have a predefined time domain relationship with the original search space 0, and the predefined time domain relationship may be known by the terminal as a predefined rule, or may be indicated in the PBCH.

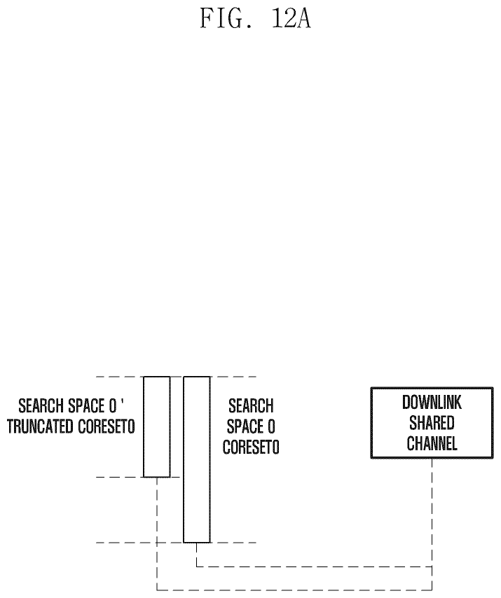

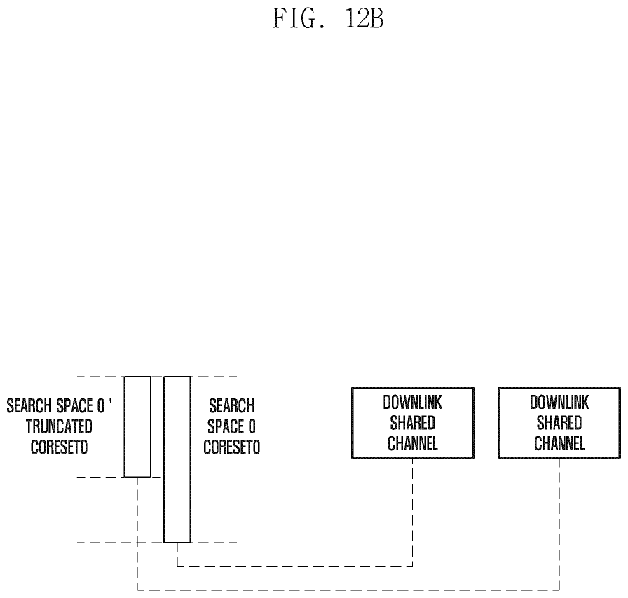

In an embodiment, the reduced-capability terminal performs PDCCH reception at the detection occasions determined by the newly configured search space 0, wherein the new search space 0 is represented by search space 0′. The search space 0′ may be the same as or different from the search space 0. When the two search spaces are the same, this embodiment may be the same as the embodiments of the above method 1; and when the two search spaces are different, the reduced-capability terminal and other capability terminals detect different PDCCHs, and their corresponding PDSCHs may be the same or different, as illustrated in FIG. 12a and FIG. 12b.

In various embodiments, the search space 0′ and search space 0 may have a predefined relationship. In a specific embodiment, the predefined relationship between the search space 0′ and search space 0 may comprise at least one of the following: the symbol number interval between the first symbol of search space 0′ and the first symbol of search space 0 is delta0; the time slot interval between the search space 0′ and search space 0 is delta1; and the system frame number interval between the search space 0′ and search space 0 is delta2. The above intervals may be indicated in the PBCH in a predefined manner. Alternatively, the predefined relationship may be known by the terminal as a predetermined rule.

Method 3: The terminal receives a new control resource set CORESET0 and a new search space 0 configuration, and uses the newly configured search space 0 and the new control resource set 0 to perform downlink control channel detection. This method can improve the detection performance of the downlink control channel by the reduced-capability terminal.

The terminal first determines whether it is a reduced-capability terminal and the supported bandwidth is a predefined value. When the conditions are met, the terminal performs downlink control channel detection according to the new CORESET0 and new search space 0.

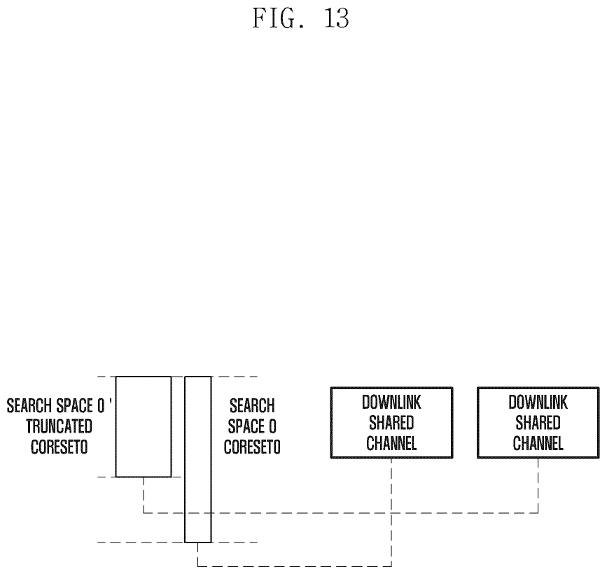

In an embodiment, the configuration of the new control resource set CORESET0 is represented by CORESET0′, the newly configured search space 0 is represented by search space 0′. The reduced-capability terminal performs downlink control channel detection according to the above configurations, and other types of terminals perform downlink control channel detection according to CORESET0 and search space 0, wherein two downlink control channels may correspond to the same downlink shared channel or different downlink shared channels, as illustrated in FIG. 13.

In one embodiment, the search space 0′ may be predefined as follows: the symbol number interval between the first symbol thereof and the first symbol of the search space 0 being delta0, and the slot interval of the two is delta1, and the system frame number interval of the two is delta2. The above intervals may be indicated in the PBCH in a predefined manner. Alternatively, the predefined relationship may be known by the terminal as a predetermined rule.

Obtaining the configuration of the new control resource set CORESET0 may comprise at least one of the following methods.

Sub-method 1: The terminal determines the frequency band information, receives the control resource set 0 configuration according to a predefined configuration, and performs control channel detection.

This method does not require to determine the cell bandwidth, and does not require to look up the table according to the CORESET0 configuration in the MIB, which reduces the processing steps of the terminal, and has good flexibility when introducing new frequency bands corresponding to different minimum channel bandwidths.

The terminal first determines whether it is in a predetermined frequency band, and if this condition is met, the terminal receives the downlink control channel according to the predefined CORESET0 frequency domain position, CORESET0 RB number, and symbol number. For the terminal that does not meet the determination condition, it looks up the CORESET0 table according to the minimum channel bandwidth supported by the frequency band in which it is located, SSB subcarrier spacing and PDCCH subcarrier spacing, and determines the CORESET0 configuration from the CORESET0 table found according to the configuration in the MIB.

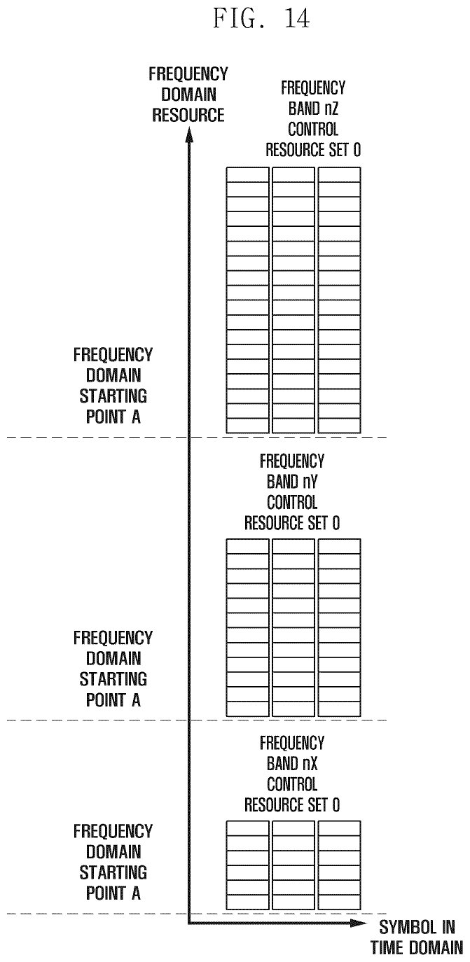

In an embodiment, the protocol introduces new frequency bands nX, nY, and nZ in the FR1 frequency band to support the future railway mobile communication system. The terminal first performs detection to determine whether the frequency band in which it is located is in a predefined frequency band according to the SSB. If the terminal is in the frequency band nX, reception of the downlink control channel is performed according to the number of RBs in CORESET0 being 18, the number of symbols being 3, and the starting position of the frequency domain of CORESET0 being pointA. If the terminal is in the frequency band nY, reception of the downlink control channel is performed according to the number of RBs in CORESET0 being 12, the number of symbols being 3, and the starting position of the frequency domain of CORESET0 being pointA. If the terminal is in the frequency band nZ, reception of the downlink control channel is performed according to the number of RBs in CORESET0 being 6, the number of symbols being 3, and the starting position of the frequency domain of CORESET0 being pointA, as illustrated in FIG. 14. In addition, the number of CORESET0 symbols with the number of symbols exceeding 3 may also be predefined according to different frequency bands.

Sub-method 2: A predefined CORESET0 configuration table is introduced in a predefined frequency band, and the terminal looks up the predefined CORESET0 configuration table in the predefined frequency band to determine the CORESET0 configuration.

In an embodiment, the terminal first determines whether the frequency band in which it is located is a predefined frequency band, and if the condition is met, it looks up the predefined CORESET0 configuration table to determine the number of RBs of the CORESET0 configuration, the number of symbols, and the frequency domain position, wherein the number of symbols in the CORESET0 supported in the predefined table may be greater than 3.

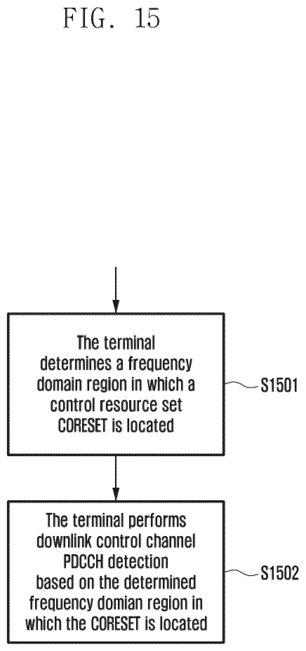

FIG. 15 illustrates a flowchart of a method performed by a terminal according to an embodiment of the present disclosure.

In step 1501, the terminal determines a frequency domain region in which a control resource set (CORESET) is located, wherein the frequency domain region in which the CORESET is located comprise at least a part of a frequency domain region of CORESET0 determined based on a master information block (MIB) configuration.

In step 1502, the terminal performs Physical Downlink Control Channel (PDCCH) detection based on the determined frequency domain region in which the CORESET is located.

In one embodiment, the frequency domain region of CORESET0 determined with the Master Information Block (MIB) configuration comprises at least one of the following: a corresponding frequency domain region of a predefined configuration corresponding to a specific frequency band; and a frequency domain region in a configuration in a configuration table corresponding to a specific frequency band.

In one embodiment, the frequency domain region in which the control resource set (CORESET) is located is determined according to at least one of the following: a frequency domain region of CORESET0 determined based on the master information block (MIB) configuration; and/or a predefined frequency domain region.

In one embodiment, the frequency domain region in which the control resource set (CORESET) is located has a maximum integer number of resource blocks (RBs) in a channel bandwidth corresponding to a predefined frequency domain region.

In one embodiment, the predefined frequency domain region comprises one of the following: a frequency domain region determined based on a cell bandwidth and/or a frequency domain starting point; a frequency domain region determined by the following: a frequency position and channel bandwidth determined according to a SSB specific subcarrier; a frequency domain region occupied by the SSB; a frequency domain region determined by the following: a frequency position and channel bandwidth determined by a specific subcarrier in CORESET0 of the Master Information Block (MIB) configuration; and a frequency domain region determined based on a part of a frequency domain region occupied by the SSB.

In one embodiment, the SSB specific subcarrier comprise one of the following: a first subcarrier of the 10th resource block RB of the SSB, a subcarrier with the highest index in the SSB, and a subcarrier with the lowest index in the SSB; or

In one embodiment, the specific subcarrier in CORESET0 of the Master Information Block (MIB) configuration comprises one of the following: a frequency domain center subcarrier of CORESET0, a subcarrier with the highest index in the frequency domain of CORESET0, and a subcarrier with the lowest index in the frequency domain of CORESET0.

In one embodiment, the frequency domain center subcarrier of CORESET0 is a first subcarrier of the Xth RB, and wherein X is a number of RBs of CORESET0 determined by the master information block (MIB) configuration divided by 2.

In one embodiment, a part of the frequency domain region occupied by the SSB is a frequency domain region corresponding to all of frequency domain positions of a Primary Synchronization Signal (PSS) and a Secondary Synchronization Signal (SSS), and a part of frequency domain positions in Physical Broadcast Channel (PBCH).

In various embodiments, the method further comprises: determining a specific search space, wherein the specific search space is spaced by a predefined value in time domain from a search space 0 determined based on the MIB configuration, and wherein the Physical Downlink Control Channel (PDCCH) detection is also performed based on the determined specific search space.

In one embodiment, the specific search space is indicated in Physical Broadcast Channel (PBCH); or the predefined value is indicated in the PBCH.

In one embodiment, the predefined values comprise at least one of the following: a symbol interval delta0 between a number of a first symbol of the specific search space and a number of a first symbol of search space 0; a slot interval delta1 between the specific search space and search space 0; and a system frame number interval delta2 between the specific search space and search space 0.

According to another method of the present disclosure, there is provided a terminal comprising: a transceiver; and at least one processor connected to the transceiver and configured to perform the above methods.

According to another method of the present disclosure, there is provided a method performed by a base station, the method comprising: transmitting a specific control resource set CORESET0 configuration to a terminal; and transmitting a Physical Downlink Control Channel (PDCCH) to the terminal based on a frequency domain region determined by the specific control resource set CORESET0 configuration.

In one embodiment, the frequency domain region determined by the specific control resource set CORESET0 configuration comprises at least one of the following: a corresponding frequency domain region in a predefined configuration corresponding to a specific frequency band; a frequency domain region corresponding to a configuration of a configuration table corresponding to a specific frequency band; and a frequency domain region determined based on a cell bandwidth and/or a frequency domain starting point.

In one embodiment, the method further comprises: transmitting a specific search space configuration to the terminal, wherein transmitting the PDCCH is further based on the search space configuration.

In one embodiment, information of the specific search space configuration is indicated in Physical Broadcast Channel (PBCH).

In one embodiment, information of the specific search space configuration comprises a predefined value of a spacing in time domain between the specific search space and search space 0 determined based on the MIB configuration.

In one embodiment, the predefined values comprise at least one of the following: a symbol interval delta0 between a number of a first symbol of the specific search space and a number of a first symbol of search space 0; a slot interval delta1 between the specific search space and search space 0; and a system frame number interval delta2 between the specific search space and search space 0.

Optionally, as an independent embodiment, the network device configures the initial uplink bandwidth of the terminal device. The terminal first judges whether it is a reduced-capability terminal and whether the minimum bandwidth capability is a predefined value, and/or whether the frequency domain resources occupied by the uplink initial bandwidth are greater than the RF bandwidth of the terminal equipment. When this condition(s) is met, the terminal first truncates the frequency domain range occupied by the initial uplink bandwidth according to RF bandwidth of the terminal, and sends PUCCH in the truncated initial uplink bandwidth for feedback of uplink control information. Specifically, the terminal equipment can determine the location of the terminal's RF center according to the above method of truncating SSB and/or CORESET0 (such as the sub-method 1), and the terminal can truncate the uplink initial bandwidth part according to the location of the RF center and RF bandwidth. Then, the terminal determines the frequency domain resource location of PUCCH within the frequency domain of the truncated uplink initial bandwidth part for feedback of uplink control information according to the PUCCH resource configuration in the uplink initial bandwidth part. This method makes the uplink initial bandwidth part within the RF bandwidth of the terminal and thus facilitating the transmission of the uplink control channel. At the same time, this method reduces the RF migration of the terminal, and reduces the complexity and energy consumption of the terminal.

In one embodiment, the terminal equipment receives configuration for the uplink initial bandwidth part configured by the network equipment. The configuration for the uplink initial bandwidth part at least includes indication of the frequency domain range occupied by the uplink initial bandwidth part and PUCCH resource configuration information. The PUCCH resource configuration information is shown in Table 2. The PUCCH resource configuration information includes one or more of the following: PUCCH resource index, PUCCH format, starting symbol, number of symbols, PRB offset, and a set of initial cycle shift index.

### Table 2 PUCCH Resource Configuration Information

TABLE 2

| | | | | | A set of |
|---|---|---|---|---|---|
| PUCCH | PUCCH | Starting | Number of | PRB offset | initial cycle |
| resource | format | symbol | symbols | RB_{BWP}^{offset} | shift index |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | └N_{BWP}^{size}/4┘ | {0, 3, 6, 9} |

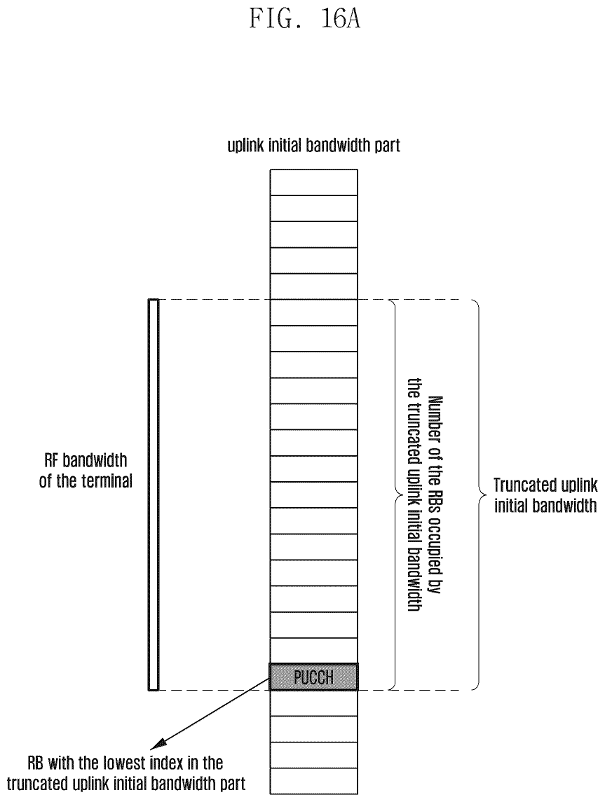

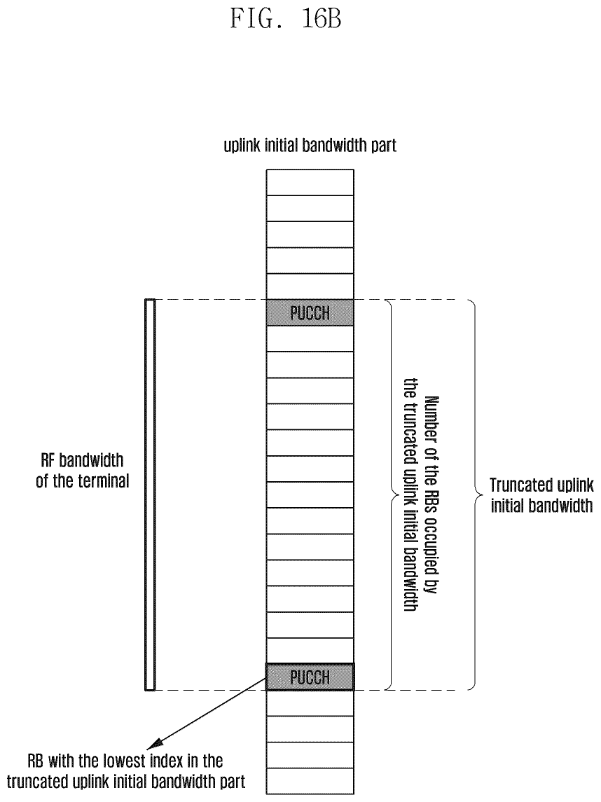

The terminal equipment truncates the initial uplink bandwidth according to the determined RF center location and RF bandwidth. The terminal equipment determines a PUCCH resource according to the PUCCH resource configuration information. The PUCCH resource is within the frequency domain corresponding to the truncated uplink initial bandwidth part, and the terminal sends uplink control information on the PUCCH resource. As shown in FIG. 16a or 16b, take the PUCCH resource corresponding to PUCCH resource index 0 as an example. FIG. 16a shows that frequency hopping is not configured or indicated in the PUCCH resource configuration information. FIG. 16b shows that the frequency hopping is configured or indicated in the PUCCH resource configuration information. If the frequency hopping is not configured or indicated in the PUCCH resource configuration information, only the lowest PRB index of the first PUCCH hop is determined. Specifically, if frequency hopping is configured in the PUCCH resource configuration, and the PUCCH resource index used is determined to be one of 0˜7, the lowest PRB index of the first hop of the PUCCH is:

$${RB}_{BWP}^{offset} \cdot {N}_{RB} + ⌊ {r}_{PUCCH} / {N}_{CS} ⌋ \cdot {N}_{RB} \qquad ( Formula 1 )$$

The lowest PRB index of the second hop of the PUCCH is:

$${N}_{BWP}^{size} - {RB}_{BWP}^{offset} \cdot {N}_{RB} - ( 1 + ⌊ {r}_{PUCCH} / {N}_{CS} ⌋ ) \cdot {N}_{RB} \qquad ( Formula 2 )$$

If frequency hopping is configured in the PUCCH resource configuration, and the PUCCH index used is determined to be one of 8˜15, the lowest PRB index of the first hop of the PUCCH is:

$${N}_{BWP}^{size} - {RB}_{BWP}^{offset} \cdot {N}_{RB} - ( 1 + ⌊ ( {r}_{PUCCH} - 8 ) / {N}_{CS} ⌋ ) \cdot {N}_{RB} \qquad ( Formula 3 )$$

The lowest PRB index of the second hop of the PUCCH is:

$${RB}_{BWP}^{offset} \cdot {N}_{RB} + ⌊ ( {r}_{PUCCH} - 8 ) / {N}_{CS} ⌋ \cdot {N}_{RB} \qquad ( Formula 4 )$$

If the PUCCH resource configuration does not configure frequency hopping, only the lowest PRB index of the first PUCCH hop is determined.

PRB offset RB_{BWP}^{offset} is the number of RBs separated between the initial RB of the PUCCH resource and the initial RB of the truncated uplink initial bandwidth part, and/or N_{BWP}^{size} is the RB number of the initial bandwidth of the uplink after truncation. BWP Furthermore, the above definitions of PRB offset RB_{BWP}^{offset} and/or parameter N_{BWP}^{size} can be used when certain premises are met. For example, on the premise that the terminal equipment is a reduced-capability terminal and the minimum bandwidth capability is a predefined value, and/or the frequency domain resource occupied by the uplink initial bandwidth part is greater than the RF bandwidth of the terminal equipment, the PRB offset RB_{BWP}^{offset} is defined as the number of RBs separated between the initial RB of the PUCCH resource and the initial RB of the truncated uplink initial bandwidth part, and/or N_{BWP}^{size} is the RB number of the truncated uplink initial N BWP bandwidth part. If the above conditions are not met, the PRB offset value offset is RB_{BWP}^{offset} the number of RBs separated between the initial RB of the PUCCH resource and the initial RB of the uplink initial bandwidth part, N_{BWP}^{size} refers to the number of RBs in the uplink initial bandwidth part. In addition, in Formula 1 to Formula 4, N_{RB} is the number of RBs occupied by the determined PUCCH, r_{PUCCH} is the PUCCH resource index used for determination, N_{CS} is the size of the initial cyclic shift set, that is, the number of initial cyclic shifts included.

In one embodiment, the terminal equipment receives configuration for the uplink initial bandwidth part configured by the network equipment. The configuration for the uplink initial bandwidth part at least includes the indication of the frequency domain range occupied by the uplink initial bandwidth part and the PUCCH resource configuration information. The PUCCH resource configuration information is shown in Table 2. The PUCCH resource configuration information includes one or more of the following: PUCCH resource index, PUCCH format, starting symbol, number of symbols, PRB offset, and a set of initial cyclic shift index.

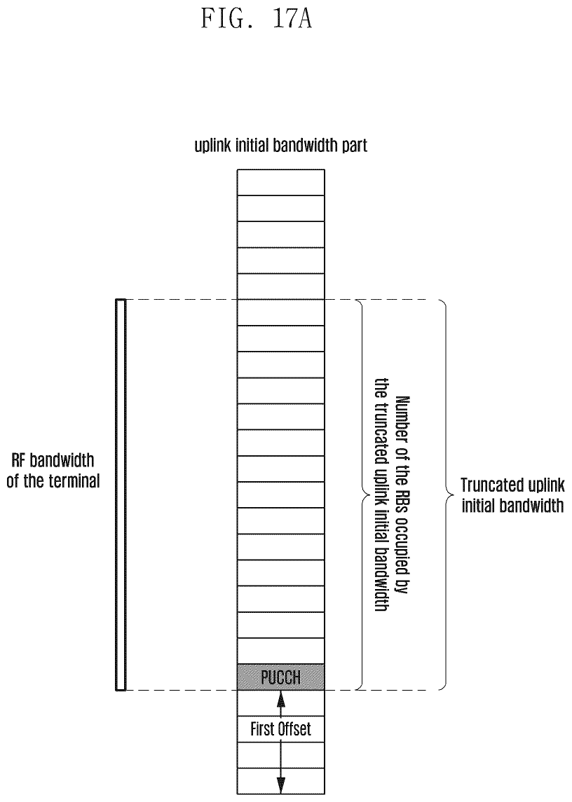

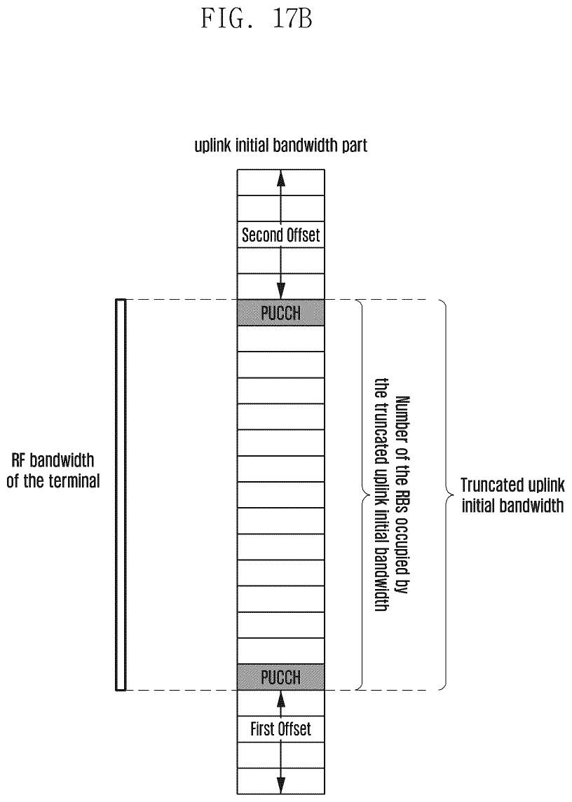

For example, on the premise that the terminal equipment is a reduced-capability terminal and the minimum bandwidth capability is a predefined value, and/or the frequency domain resource occupied by the uplink initial bandwidth part is greater than the RF bandwidth of the terminal equipment, the terminal equipment can truncate the uplink initial bandwidth according to the determined location of the RF center and the RF bandwidth. The terminal equipment determines a PUCCH resource according to the PUCCH resource configuration information. The PUCCH resource is within the frequency domain corresponding to the truncated uplink initial bandwidth part, and the terminal sends uplink control information on the PUCCH resource. As shown in FIG. 17a or 17b, take the PUCCH resource corresponding to PUCCH resource index 0 as an example. FIG. 17a is a case that frequency hopping is not configured, and FIG. 17b is a case that frequency hopping is configured. If the PUCCH resource configuration does not configure frequency hopping, only the lowest PRB index of the first PUCCH hop is determined.

Specifically, if frequency hopping is configured in the PUCCH resource configuration, and the PUCCH resource index used is determined to be one of 0˜7, the lowest PRB index of the first PUCCH hop is:

$${RB}_{BWP}^{offset} \cdot {N}_{RB} + ⌊ {r}_{PUCCH} / {N}_{CS} ⌋ \cdot {N}_{RB} + first offset value \qquad ( Formula 5 )$$

The lowest PRB index of the second hon of the PUCCH is:

$${N}_{BWP}^{size} - {RB}_{BWP}^{offset} \cdot {N}_{RB} - ( 1 + ⌊ {r}_{PUCCH} / {N}_{CS} ⌋ ) \cdot {N}_{RB} - Second offset value \qquad ( Formula 6 )$$

If frequency hopping is configured in the PUCCH resource configuration, and the PUCCH index used is determined to be one of 8˜15, the lowest PRB index of the first hop of the PUCCH is:

$${N}_{BWP}^{size} - {RB}_{BWP}^{offset} \cdot {N}_{RB} - ( 1 + ⌊ ( {r}_{PUCCH} - 8 / {N}_{CS} ⌋ ) \cdot {N}_{RB} + first offset value \qquad ( Formula 7 )$$

The lowest PRB index of the second hop of the PUCCH is:

$${RB}_{BWP}^{offset} \cdot {N}_{RB} + ⌊ ( {r}_{PUCCH} - 8 ) / {N}_{CS} ⌋ \cdot {N}_{RB} + second offset value \qquad ( Formula 8 )$$

Wherein, PRB offset RB_{BWP}^{offset} is the number of RBs separated between the initial RB of the PUCCH resource and the initial RB of the uplink initial bandwidth part, N_{BWP}^{size} is the number of RBs in the uplink initial bandwidth part, N_{RB} is the number of RBs occupied by the determined PUCCH, r_{PUCCH} is the PUCCH resource index used for determination, N_{CS} is the size of the initial cyclic shift set, that is, the number of initial cyclic shifts included.

The first offset value and the second offset value are notified through high-layer signaling. The PUCCH resources determined by the terminal equipment through Formula 5 to Formula 8 above are completely included in the truncated uplink initial bandwidth part.

Optionally, the first offset value is equal to the second offset value, or the network device notifies an offset value through high-layer signaling which is used in Formula 5 to Formula 8, or the network device notifies four offset values through high-layer signaling which are used for Formula 5 to Formula 8, respectively.

According to another aspect of the present disclosure, there is provided a base station comprising: a transceiver; and at least one processor connected to the transceiver and configured to perform the above methods.

Although one or more embodiments have been described with reference to the accompanying drawings, persons of ordinary skill in the art shall understand that various changes in form and details may be made therein without departing from the spirit and scope as defined by the appended claims.

1. A method performed by user equipment (UE) in a communication system, the method comprising:
receiving a truncated synchronization signal/physical broadcast channel (SS/PBCH) block;
identifying a control resource set 0 (CORESET0) based on the truncated SS/PBCH block and an offset, wherein the offset represents a number of resource blocks (RBs) between an RB with smallest index for the CORESET0 and an RB with smallest index for the truncated SS/PBCH block; and
receiving a physical downlink control channel (PDCCH) or a system information block 1 (SIB1) in the CORESET0.

2-15. (canceled)

16. The method of claim 1, wherein the CORESET0 is truncated in a predefined frequency domain region, and
wherein a number of RBs in the truncated CORESET0 is 15.

17. The method of claim 1, wherein the offset is identified based on a CORESET0 table including a number of RBs in the CORESET0 being 12.

18. The method of claim 17, wherein the CORESET0 table is used for a minimum channel bandwidth being 3 MHz, a subcarrier spacing for the CORESET0 is 15 KHz and a subcarrier spacing for the truncated SS/PBCH block is 15 KHz.

19. The method of claim 17, wherein the CORESET0 table is associated with a synchronization raster for the truncated SS/PBCH block.

20. The method of claim 1, wherein a number of RBs in the truncated SS/PBCH block is less than a number of RBs in an SS/PBCH block that is not truncated.

21. A user equipment (UE) in a communication system, the UE comprising:
a transceiver; and
a processor coupled with the transceiver and configured to:
receive a truncated synchronization signal/physical broadcast channel (SS/PBCH) block;
identify a control resource set 0 (CORESET0) based on the truncated SS/PBCH block and an offset, wherein the offset represents a number of resource blocks (RBs) between an RB with smallest index for the CORESET0 and an RB with smallest index for the truncated SS/PBCH block; and
receive a physical downlink control channel (PDCCH) for a system information block 1 (SIB1) in the CORESET0.

22. The UE of claim 21,
wherein the CORESET0 is truncated in a predefined frequency domain region, and
wherein a number of RBs in the truncated CORESET0 is 15.

23. The UE of claim 21, wherein the offset is identified based on a CORESET0 table including a number of RBs in the CORESET0 being 12.

24. The UE of claim 23, wherein the CORESET0 table is used for a minimum channel bandwidth being 3 MHz, a subcarrier spacing for the CORESET0 is 15 KHz and a subcarrier spacing for the truncated SS/PBCH block is 15 KHz.

25. The UE of claim 23, wherein the CORESET0 table is associated with a synchronization raster for the truncated SS/PBCH block.

26. The UE of claim 23, wherein a number of RBs in the truncated SS/PBCH block is less than a number of RBs in an SS/PBCH block that is not truncated.

27. A method performed by a base station in a communication system, the method comprising:
transmitting a truncated synchronization signal/physical broadcast channel (SS/PBCH) block;
identifying a control resource set 0 (CORESET0) based on the truncated SS/PBCH block and an offset, wherein the offset represents a number of resource blocks (RBs) between an RB with smallest index for the CORESET0 and an RB with smallest index for the truncated SS/PBCH block; and
transmitting a physical downlink control channel (PDCCH) for a system information block 1 (SIB1) in the CORESET0.

28. The method of claim 27,
wherein the CORESET0 is truncated in a predefined frequency domain region, and
wherein a number of RBs in the truncated CORESET0 is 15.

29. The method of claim 27, wherein the offset is identified based on a CORESET0 table including a number of RBs in the CORESET0 being 12.

30. The method of claim 29, wherein the CORESET0 table is used for a minimum channel bandwidth being 3 MHz, a subcarrier spacing for the CORESET0 is 15 KHz and a subcarrier spacing for the truncated SS/PBCH block is 15 KHz.

31. The method of claim 29, wherein the CORESET0 table is associated with a synchronization raster for the truncated SS/PBCH block.

32. The method of claim 27, wherein a number of RBs in the truncated SS/PBCH block is less than a number of RBs in an SS/PBCH block that is not truncated.

33. A base station in a communication system, the base station comprising:
a transceiver; and
a processor coupled with the transceiver and configured to:
transmit a truncated synchronization signal/physical broadcast channel (SS/PBCH) block;
identify a control resource set 0 (CORESET0) based on the truncated SS/PBCH block and an offset, wherein the offset represents a number of resource blocks (RBs) between an RB with smallest index for the CORESET0 and an RB with smallest index for the truncated SS/PBCH block; and
transmit a physical downlink control channel (PDCCH) for a system information block 1 (SIB1) in the CORESET0.

34. The base station of claim 33,
wherein the CORESET0 is truncated in a predefined frequency domain region, and
wherein a number of RBs in the truncated CORESET0 is 15.

35. The base station of claim 33, wherein the offset is identified based on a CORESET0 table including a number of RBs in the CORESET0 being 12.

36. The base station of claim 35, wherein the CORESET0 table is used for a minimum channel bandwidth being 3 MHz, a subcarrier spacing for the CORESET0 is 15 KHz and a subcarrier spacing for the truncated SS/PBCH block is 15 KHz.

37. The base station of claim 35, wherein the CORESET0 table is associated with a synchronization raster for the truncated SS/PBCH block.

38. The base station of claim 33, wherein a number of RBs in the truncated SS/PBCH block is less than a number of RBs in an SS/PBCH block that is not truncated.
